(19) United States
(12) Patent Application Publication
(10) Pub. No.: US 2025/0262912 A1
(43) Pub. Date: Aug. 21, 2025

(54) VEHICULAR HEAT PUMP CYCLE DEVICE

(71) Applicant: DENSO CORPORATION, Kariya-City (JP)

(72) Inventors: Hiroyuki KOBAYASHI, Kariya-City (JP); Atsushi Inaba, Kariya-City (JP); Yuichi Kami, Kariya-City (JP); Daiki Kato, Kariya-City (JP)

(21) Appl. No.: 19/198,517

(22) Filed: May 5, 2025

Related U.S. Application Data
(63) Continuation of application No. PCT/JP2023/036970, filed on Oct. 12, 2023.

(30) Foreign Application Priority Data
Nov. 9, 2022 (JP) 2022-179484

(51) Int. Cl. B60H 1/32

(52) U.S. Cl. CPC B60H 1/3228

(57) ABSTRACT

The configuration enables to suppress noise of a compressor while ensuring a necessary heating capacity. a compressor configured to draw, compress, and discharge refrigerant; a heating unit configured to heat an object to be heated using, as a heat source, refrigerant discharged from the compressor; a decompression unit configured to decompress refrigerant flowing out of the heating unit; and a heat absorbing unit configured to cause refrigerant, which is decompressed by the decompression unit, to absorb heat generated by a heat generating unit. The heat absorbing unit is configured to increase an amount of absorbed heat according to decrease in the allowable noise level of the compressor.

### CROSS REFERENCE TO RELATED APPLICATION

The present application is a continuation application of International Patent Application No. PCT/JP2023/036970 filed on Oct. 12, 2023, which designated the U.S. and claims the benefit of priority from Japanese Patent Application No. 2022-179484 filed on Nov. 9, 2022. The entire disclosures of all of the above applications are incorporated herein by reference.

### TECHNICAL FIELD

The present disclosure relates to a vehicular heat pump cycle device.

### BACKGROUND

Conventionally, a vehicular heat pump cycle including a compressor and a heat exchanger has been used to produce a required heating capacity.

### SUMMARY

According to an aspect of the present disclosure, a heat pump cycle device includes a compressor, a heating unit, a decompression unit, and a heat absorbing unit.

### BRIEF DESCRIPTION OF THE DRAWINGS

The above object and other objects, features, and advantages of the present disclosure will become more apparent from the following detailed description with reference to the accompanying drawings.

FIG. 1 is a schematic overall configuration diagram showing a vehicular air conditioner according to a first embodiment.

FIG. 2 is a schematic configuration diagram showing an indoor air conditioning unit according to the first embodiment.

FIG. 3 is a block diagram showing an electric control unit of the vehicular air conditioner according to the first embodiment.

FIG. 4 is a control characteristic graph used in determination of an allowable compressor noise in the first embodiment.

FIG. 5 is a control characteristic graph used in determination of a target chiller inlet water temperature in the first embodiment.

FIG. 6 is a graph showing a relationship between a chiller inlet water temperature, a compressor rotation speed, a chiller heat absorption amount, and the amount of work of the compressor in the first embodiment.

FIG. 7 is a schematic overall configuration diagram showing a flow of refrigerant in a single hot gas dehumidification heating mode and a cooling hot gas heating mode of a heat pump cycle in the first embodiment.

FIG. 8 is a Mollier chart showing a change in the state of refrigerant in the single hot gas heating mode of the heat pump cycle in the first embodiment.

FIG. 9 is a schematic overall configuration diagram showing a vehicular air conditioner according to a second embodiment.

FIG. 10 is a schematic overall configuration diagram showing a vehicular air conditioner according to a third embodiment.

FIG. 11 is a schematic overall configuration diagram showing a vehicular air conditioner according to a fourth embodiment.

FIG. 12 is a graph showing a relationship between a chiller target superheat degree and a chiller heat absorption amount in a fifth embodiment.

### DETAILED DESCRIPTION

Hereinafter, examples of the present disclosure will be described. A vehicular heat pump cycle device according to an example of the present disclosure includes a heating unit that heats an object to be heated using a refrigerant discharged from a compressor and heat generated by a heat generating unit as heat sources.

According to an example, a vehicular heat pump cycle provides a required heating capacity (specifically, the space heating capacity) by a sum of an amount of work of of a compressor and an amount of heat absorbed from a chiller. The chiller is a heat exchanger that exchanges heat between a low-pressure refrigerant in a heat pump cycle and a low-temperature side heat medium in a low-temperature side heat medium circuit, and absorbs heat from the low-temperature side heat medium. An electric heater is provided in the low-temperature side heat medium circuit as a heat generating unit for heating the low-temperature side heat medium.

In this configuration, when the amount of heat absorbed from the chiller is small, it is necessary to increase the rotation speed of the compressor to increase the amount of work of the compressor. Increasing in the compressor speed results in increase in the compressor noise. The compressor noise is easily suppressed when the vehicle speed is high and the driving noise is loud, or when the air-conditioning indoor blower has a large air volume and the operating noise and blowing noise of the indoor blower are loud. However, when the vehicle speed is low or the air volume of the indoor blower is low, the compressor noise becomes noticeable and it may not be possible to increase the compressor rotation speed. Therefore, it may be difficult to ensure the necessary heating capacity.

According to an example of the present disclosure, a heat pump cycle device includes a compressor, a heating unit, a decompression unit, and a heat absorbing unit.

The compressor is configured to draw, compress, and discharge refrigerant. The heating unit is configured to heat an object to be heated using, as a heat source, refrigerant discharged from the compressor. The decompression unit is configured to decompress refrigerant flowing out of the heating unit. The heat absorbing unit is configured to cause refrigerant, which is decompressed by the decompression portion, to absorb heat generated by a heat generating unit. The heat absorbing unit is configured to increase an amount of absorbed heat according to decrease in an allowable noise level of the compressor.

According to this, the amount of heat absorbed in the heat absorbing unit is increased, as the allowable noise level of the compressor decreases, so that the desired heating capacity can be ensured in the heating unit even when the amount of work of the compressor (in other words, the rotation speed of the compressor) is decreased. Therefore, it is possible to suppress the noise of the compressor while ensuring the necessary heating capacity.

According to an example of the present disclosure, a heat pump cycle device includes a compressor, a heating unit, a decompression unit, a heat absorbing unit, and an upper limit rotation speed determination unit.

The compressor is configured to draw, compress, and discharge refrigerant. The heating unit is configured to heat an object to be heated using, as a heat source, refrigerant discharged from the compressor. The decompression unit is configured to decompress refrigerant flowing out of the heating unit. The heat absorbing unit is configured to cause refrigerant, which is decompressed by the decompression portion, to absorb heat generated by a heat generating unit. The upper limit rotation speed determination unit is configured to determine an upper limit rotation speed of the compressor.

The upper limit rotation speed determination unit lowers the upper limit rotation speed in accordance with decrease in the allowable noise level of the compressor. The heat absorbing unit is configured to increase an amount of absorbed heat according to decrease in an allowable noise level of the compressor.

This can produce the same effects as those of the first aspect.

Hereinafter, embodiments for implementing the present disclosure will be described referring to drawings. In the respective embodiments, parts corresponding to matters already described in the preceding embodiments are given reference numbers identical to reference numbers of the matters already described. The same description is therefore omitted depending on circumstances. In a case where only a part of the configuration is described in each embodiment, other embodiments previously described can be applied to other parts of the configuration. It is also possible to partially combine the embodiments even when it is not explicitly described, as long as there is no problem in the combination as well as the combination of the parts specifically and explicitly described that the combination is possible.

### First Embodiment

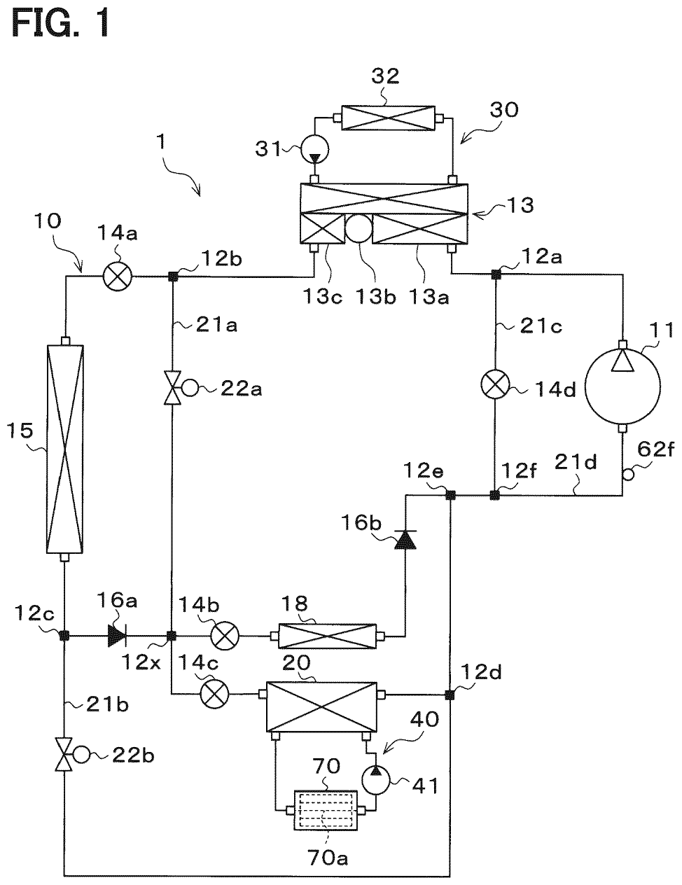

A first embodiment of a heat pump cycle device according to the present disclosure will be described with reference to FIGS. 1 to 8. In the present embodiment, the heat pump cycle device according to the present disclosure is applied to a vehicular air conditioner 1 mounted on an electric vehicle. The electric vehicle is a vehicle that obtains traveling drive force from an electric motor. The vehicular air conditioner 1 performs air conditioning in a vehicle interior, which is a space to be air conditioned, and adjusts the temperature of an in-vehicle device. Therefore, the vehicular air conditioner 1 can be referred to as an air conditioner with an in-vehicle device temperature adjustment function or an in-vehicle device temperature adjustment device with an air conditioning function.

The vehicular air conditioner 1 includes a heat pump cycle 10, a high-temperature side heat medium circuit 30, a low-temperature side heat medium circuit 40, an indoor air conditioning unit 50, a control device 60, and the like.

The heat pump cycle 10 shown in FIG. 1 is a vapor compression refrigeration cycle that adjusts the temperatures of ventilation air blown into the vehicle interior, a high-temperature side heat medium circulating in the high-temperature side heat medium circuit 30, and a low-temperature side heat medium circulating in the low-temperature side heat medium circuit 40.

The heat pump cycle 10 is configured to switch the refrigerant circuit according to various operation modes in order to perform air conditioning inside the vehicle interior. The heat pump cycle 10 uses an HFO refrigerant (specifically, R1234yf) as the refrigerant. The heat pump cycle 10 forms a subcritical refrigeration cycle in which the pressure of a high-pressure side refrigerant does not exceed the critical pressure of the refrigerant.

A refrigerator oil for lubricating a compressor 11 is mixed in the refrigerant. The refrigerant oil is a PAG oil (that is, polyalkylene glycol oil) compatible with a liquid-phase refrigerant or POE (that is, polyol ester). A part of the refrigerant oil circulates in the heat pump cycle 10 together with the refrigerant.

The compressor 11 draws, compresses, and discharges the refrigerant in the heat pump cycle 10. The compressor 11 is an electric compressor that rotationally drives a fixed capacity type compression mechanism that has a fixed discharge capacity by an electric motor. A refrigerant discharge capacity (i.e., the rotational speed) of the compressor 11 is controlled by a controlling signal transmitted from a control device 60.

The compressor 11 is provided in a drive unit chamber formed on the front side of the vehicle interior. The drive unit chamber forms a space in which at least a part of a device (for example, a motor generator as a traveling electric motor) used for generating or regulating driving force for vehicle traveling is provided.

The inflow port side of a first three-way joint 12a is connected to a discharge port of the compressor 11. The first three-way joint 12a has three inflow-outflow ports communicating with each other. As the first three-way joint 12a, a joint portion formed by joining a plurality of pipes or a joint portion formed by providing a plurality of refrigerant passages in a metal block or a resin block can be used.

The heat pump cycle 10 includes a second three-way joint 12b to a sixth three-way joint 12f. The basic configuration of each of the second three-way joint 12b, a third three-way joint 12c, a fourth three-way joint 12d, a fifth three-way joint 12e, and the sixth three-way joint 12f is the same as that of the first three-way joint 12a. The basic configuration of each three-way joint in embodiments to be described later is also similar to that of the first three-way joint 12a.

When one of the three inflow and outflow ports is used as an inflow port and the remaining two are used as outflow ports in each of these three-way joints, the flow of the refrigerant is branched. When two of the three inflow and outflow ports are used as inflow ports and the remaining one is used as an outflow port, the flows of the refrigerant are joined. The first three-way joint 12a is a branch portion that branches the flow of the discharge refrigerant discharged from the compressor 11.

The inlet side of a refrigerant passage in a water-refrigerant heat exchanger 13 is connected to one outflow port of the first three-way joint 12a. Another outflow port of the first three-way joint 12a is connected to one inflow port of the sixth three-way joint 12f.

The refrigerant passage from the other outflow port of the first three-way joint 12a to one inflow port of the sixth three-way joint 12f is a bypass passage 21c. A bypass-side flow rate regulating valve 14d is provided in the bypass passage 21c.

The bypass-side flow rate regulating valve 14d is a bypass-passage side decompression unit that decompresses a discharge refrigerant (that is, the other the discharge refrigerant branched at the first three-way joint 12a) flowing out of the other outflow port of the first three-way joint 12a in various operation modes such as the hot gas air-heating mode to be described later. The bypass-side flow rate regulating valve 14d is a bypass-side flow-rate regulating unit that regulates the flow rate (the mass flow rate) of the refrigerant flowing through the bypass passage 21c.

The bypass-side flow rate regulating valve 14d is an electric variable throttle mechanism including a valve body that changes a throttle opening and an electric actuator (specifically, stepping motor) as a drive unit that displaces the valve body. The operation of the bypass-side flow rate regulating valve 14d is controlled by a control pulse output from the control device 60.

The bypass-side flow rate regulating valve 14d has a full open function of functioning as a simple refrigerant passage without exhibiting a refrigerant decompression action and a flow rate regulating action by setting the throttle opening to a fully open state. The bypass-side flow rate regulating valve 14d has a full close function of closing the refrigerant passage by bringing the throttle opening degree to a full close state.

The heat pump cycle 10 includes an air-heating expansion valve 14a, an air-cooling expansion valve 14b, and a cooling expansion valve 14c. Each of the basic configurations of the air-heating expansion valve 14a, the air-cooling expansion valve 14b, and the cooling expansion valve 14c is similar to that of the bypass-side flow rate regulating valve 14d.

The refrigerant circuit can be switched by the air-heating expansion valve 14a, the air-cooling expansion valve 14b, the cooling expansion valve 14c, and the bypass-side flow rate regulating valve 14d exhibiting the fully closing function. Therefore, the air-heating expansion valve 14a, the air-cooling expansion valve 14b, the cooling expansion valve 14c, and the bypass-side flow rate regulating valve 14d function as a refrigerant circuit switching unit.

The air-heating expansion valve 14a, the air-cooling expansion valve 14b, the cooling expansion valve 14c, and the bypass-side flow rate regulating valve 14d may be formed by combining a variable throttle mechanism that does not have a fully closing function and an on-off valve that opens and closes a throttle passage. In this case, each on-off valve functions as the refrigerant circuit switching unit.

The water-refrigerant heat exchanger 13 is a heat-radiating heat exchange unit that exchanges heat between the high-pressure refrigerant discharged from the compressor 11 and the high-temperature side heat medium circulating in the high-temperature side heat medium circuit 30 to radiate heat of the high-pressure refrigerant to the high-temperature side heat medium. The water-refrigerant heat exchanger 13 is a heating unit that uses the refrigerant discharged from the compressor 11 as a heat source to heat the high-temperature side heat medium, which is an object to be heated.

In the present embodiment, a so-called sub-cool heat exchanger is used as the water-refrigerant heat exchanger 13. For this reason, a condensing portion 13a, a receiver 13b, and a sub-cooling portion 13c are provided in the refrigerant passage of the water-refrigerant heat exchanger 13.

The condensing portion 13a is a condensing heat exchange unit that exchanges heat between the high-pressure refrigerant discharged from the compressor 11 and the high-pressure side heat medium to condense the high-pressure refrigerant. The receiver 13b is a high-pressure side gas-liquid separating unit that separates the refrigerant flowing out of the condensing portion 13a into gas and liquid and stores the separated liquid-phase refrigerant as an excess refrigerant in the cycle. The sub-cooling portion 13c is a sub-cooling heat exchange unit that exchanges heat between the liquid-phase refrigerant flowing out of the receiver 13b and the high-temperature heat medium to sub-cool the liquid-phase refrigerant.

An inflow port side of the second three-way joint 12b is connected to an outflow port of the refrigerant passage of the water-refrigerant heat exchanger 13 (specifically, the outflow port of the sub-cooling portion 13c). An inlet side of an air-heating expansion valve 14a is connected to one outflow port of the second three-way joint 12b. One inflow port side of a four-way joint 12x is connected to the other outflow port of the second three-way joint 12b.

The refrigerant passage from the other outflow port of the second three-way joint 12b to one inflow port of the four-way joint 12x is a dehumidifying passage 21a. A dehumidifying on-off valve 22a is provided in the dehumidifying passage 21a.

The dehumidifying on-off valve 22a is an on-off valve that opens and closes the dehumidifying passage 21a. The dehumidifying on-off valve 22a is an electromagnetic valve whose opening and closing operation is controlled by a control voltage output from the control device 60. The dehumidifying on-off valve 22a can switch the refrigerant circuit by opening and closing the dehumidifying passage 21a. Therefore, the dehumidifying on-off valve 22a is a refrigerant circuit switching unit.

The four-way joint 12x is a joint portion having four inflow and outflow ports communicating with each other. As the four-way joint 12x, a joint portion formed in the same manner as the above-described three-way joint can be adopted. As the four-way joint 12x, one formed by combining two three-way joints may be employed.

The air-heating expansion valve 14a is an outdoor heat-exchanger side decompression unit that decompresses the refrigerant flowing into an outdoor heat exchanger 15 in an air-heating mode and the like among the various operation modes. The air-heating expansion valve 14a is a flow-rate regulating unit on the outdoor heat exchanger side that regulates the flow rate (the mass flow rate) of the refrigerant flowing into the outdoor heat exchanger 15.

A refrigerant inlet side of the outdoor heat exchanger 15 is connected to an outlet of the air-heating expansion valve 14a. The outdoor heat exchanger 15 is an outside air heat exchange unit that exchanges heat between the refrigerant flowing out of the air-heating expansion valve 14a and outside air blown by an outside air fan (not illustrated). The outdoor heat exchanger 15 is provided on the front side of the drive unit chamber. For this reason, during traveling of the vehicle, the traveling air flowing into the drive unit chamber through a grill can be blown against the outdoor heat exchanger 15.

An inflow port of the third three-way joint 12c is connected to the refrigerant outlet of the outdoor heat exchanger 15. Another inflow port side of the four-way joint 12x is connected to one outflow port of the third three-way joint 12c via a first check valve 16a. Another outflow port of the third three-way joint 12c is connected to one inflow port of the fourth three-way joint 12d.

The refrigerant passage from the other outflow port of the third three-way joint 12c to one inflow port of the fourth three-way joint 12d is an air-heating passage 21b. An air-heating on-off valve 22b is provided in the air-heating passage 21b.

The air-heating on-off valve 22b is an on-off valve that opens and closes the air-heating passage 21b. The basic configuration of the air-heating on-off valve 22b is the same as that of the dehumidifying on-off valve 22a. Therefore, the air-heating on-off valve 22b is a refrigerant circuit switching unit. The basic configuration of each on-off valve described in the embodiments to be described later is also similar to that of the dehumidifying on-off valve 22a.

The first check valve 16a allows the refrigerant to flow from the third three-way joint 12c side to the four-way joint 12x side, and inhibits the refrigerant from flowing from the four-way joint 12x side to the third three-way joint 12c side.

The refrigerant inflow port side of an indoor evaporator 18 is connected to one outflow port of the four-way joint 12x via the air-cooling expansion valve 14b.

The air-cooling expansion valve 14b is a decompression unit on the indoor evaporator side that decompresses the refrigerant flowing into the indoor evaporator 18 in an air-cooling mode, a hot gas dehumidifying air-heating mode, or the like among the various operation modes. Therefore, the air-cooling expansion valve 14b serves as a heating-unit side decompression unit in the hot gas dehumidifying air-heating mode or the like. The air-cooling expansion valve 14b is also a flow-rate regulating unit on the indoor evaporator side that regulates the flow rate (the mass flow rate) of the refrigerant flowing into the indoor evaporator 18.

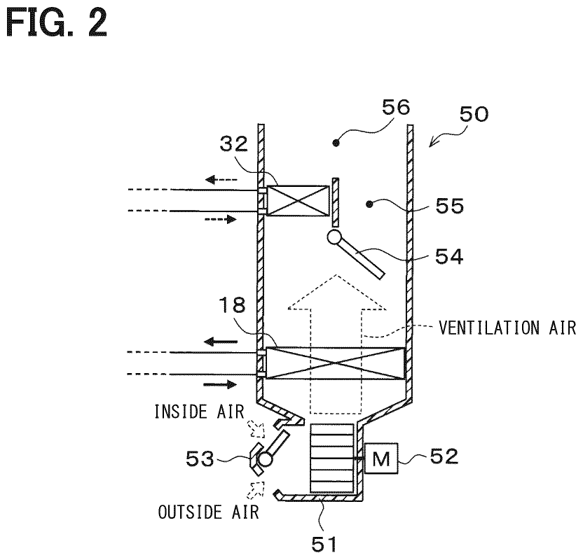

The indoor evaporator 18 is provided in an air conditioning case 51 of the indoor air conditioning unit 50 shown in FIG. 2. The indoor evaporator 18 is an air-cooling heat exchange unit that exchanges heat between the low-pressure refrigerant decompressed by the air-cooling expansion valve 14b and ventilation air blown from an indoor blower 52 toward the vehicle interior. In the indoor evaporator 18, the ventilation air is cooled by evaporating the low-pressure refrigerant to exhibit the heat absorbing action.

One inflow port side of the fifth three-way joint 12e is connected to a refrigerant outflow port of the indoor evaporator 18 via a second check valve 16b. The second check valve 16b allows the refrigerant to flow from the refrigerant outflow port side of the indoor evaporator 18 to the fifth three-way joint 12e side, and prohibits the refrigerant from flowing from the fifth three-way joint 12e side to the refrigerant outflow port side of the indoor evaporator 18.

An inflow port side of a refrigerant passage in a chiller 20 is connected to another outflow port of the four-way joint 12x via the cooling expansion valve 14c.

The cooling expansion valve 14c is a chiller-side decompression unit that decompresses the refrigerant flowing into the chiller 20 in, for example, a cooling and air-cooling mode, the hot gas air-heating mode, or the like among the various operation modes. Therefore, the cooling expansion valve 14c serves as a heating-unit side decompression unit in the hot gas air-heating mode or the like. The cooling expansion valve 14c is also a chiller-side flow-rate regulating unit that regulates the flow rate (the mass flow rate) of the refrigerant flowing into the chiller 20.

The chiller 20 is a temperature-regulating heat exchange unit that exchanges heat between the low-pressure refrigerant decompressed by the cooling expansion valve 14c and the low-temperature side heat medium circulating in the low-temperature side heat medium circuit 40. In the chiller 20, the low-pressure refrigerant is evaporated to exert a heat absorbing effect, so that the heat held by the low-temperature heat medium is absorbed by the low-pressure refrigerant.

The other inflow port side of the fourth three-way joint 12d is connected to an outflow port of the refrigerant passage in the chiller 20. The other inflow port side of the fifth three-way joint 12e is connected to an outflow port of the fourth three-way joint 12d. The other inflow port side of the sixth three-way joint 12f is connected to an outflow port of the fifth three-way joint 12e. An inflow port side of the compressor 11 is connected to an outflow port of the sixth three-way joint 12f.

Accordingly, in the hot gas air-heating mode or the like, the sixth three-way joint 12f serves as a joining unit that joins the flow of the heating-unit side refrigerant flowing out of the heating-unit side decompression unit and the flow of the bypass-side refrigerant flowing out of the bypass-side flow rate regulating valve 14d, and causes the joined flow to flow to the inflow port side of the compressor 11.

The refrigerant passage from the outflow port of the sixth three-way joint 12f to the suction port of the compressor 11 is a suction-side passage 21d forming a suction-side passage.

The high-temperature side heat medium circuit 30 is a heat medium circulation circuit that circulates the high-temperature side heat medium. In the present embodiment, an ethylene glycol aqueous solution is used as the high-temperature side heat medium. In the high-temperature side heat medium circuit 30, the heat medium passage of the water-refrigerant heat exchanger 13, a high-temperature side pump 31, a heater core 32, and the like are provided.

The high-temperature side pump 31 is a high-temperature side heat medium pressure transfer unit that pressure-feeds the high-temperature side heat medium flowing out of the heat medium passage of the water-refrigerant heat exchanger 13 to the heat medium inlet side of the heater core 32. The high-temperature side pump 31 is an electric pump whose rotation speed (that is, the pumping capability) is controlled by a control voltage output from the control device 60.

The heater core 32 is a heating heat exchanger that exchanges heat between the high-temperature side heat medium heated by the water-refrigerant heat exchanger 13 and the ventilation air passing through the interior evaporator 18 to heat the ventilation air. The heater core 32 is provided in the air conditioning case 51 of the indoor air conditioning unit 50. The inlet side of a heat medium passage of the water-refrigerant heat exchanger 13 is connected to the heat medium outlet of the heater core 32.

Therefore, the constituent devices of the water-refrigerant heat exchanger 13 and the high-temperature side heat medium circuit 30 of the present embodiment are heating units that heat ventilation air as an object to be heated using one discharge refrigerant branched at the first three-way joint 12a as a heat source.

Next, the low-temperature side heat medium circuit 40 will be described. The low-temperature side heat medium circuit 40 is a heat medium circuit that circulates the low-temperature side heat medium. In the present embodiment, the same type of fluid as the high-temperature side heat medium is used as the low-temperature side heat medium. A low-temperature side pump 41, a cooling water passage 70a of an electric heater 70, the heat medium passage of the chiller 20, and the like are connected to the low-temperature side heat medium circuit 40.

The low-temperature side pump 41 is a low-temperature side heat medium pressure transfer unit that pressure-feeds the low-temperature side heat medium flowing out of the cooling water passage 70a of the electric heater 70 to the inlet side of the heat medium passage of the chiller 20. The basic configuration of the low-temperature side pump 41 is similar to that of the high-temperature side pump 31. The inlet side of the cooling water passage 70a of the electric heater 70 is connected to the outlet side of the heat medium passage of the chiller 20. The electric heater 70 is a heating element that generates heat when electric power is supplied to heat the high-temperature side heat medium. The heat medium heating capacity (i.e., the heat generation amount) of the electric heater 70 is controlled by a control signal output from the control device 60.

The cooling water passage 70a of the electric heater 70 is a cooling water passage formed to cool the electric heater 70 by causing the low-temperature side heat medium cooled by the chiller 20 to flow therethrough.

The passage configuration of the cooling water passage 70a is a passage configuration in which a plurality of passages are connected in parallel inside the battery-dedicated case. As a result, all the battery cells can be uniformly cooled in the cooling water passage 70a. The inflow port side of the low-temperature side pump 41 is connected to the outlet of the cooling water passage 70a.

Next, the indoor air conditioning unit 50 will be described with reference to FIG. 2. The indoor air conditioning unit 50 is a unit in which a plurality of components are integrated in order to blow ventilation air whose temperature has been adjusted to an appropriate temperature for air conditioning in the vehicle interior to an appropriate location in the vehicle interior. The indoor air conditioning unit 50 is provided inside an instrument panel (the instrument panel) at the foremost part of the vehicle interior.

The indoor air conditioning unit 50 is formed by housing the indoor blower 52, the indoor evaporator 18, the heater core 32, and the like in the air conditioning case 51 forming an air passage for ventilation air. The air conditioning case 51 is made of resin (for example, polypropylene) with a certain degree of elasticity and excellent strength.

An inside and outside air switching device 53 is provided on the most upstream side of ventilation air flow in the air conditioning case 51. The inside and outside air switching device 53 switchingly introduces inside air (that is, air inside vehicle interior) and outside air (that is, air outside vehicle interior) into the air conditioning case 51. Operation of the inside and outside air switching device 53 is controlled by a control signal output from the control device 60.

The indoor blower 52 is provided on the ventilation air flow downstream side of the inside and outside air switching device 53. The indoor blower 52 is an air blower unit that blows air drawn through the inside and outside air switching device 53, toward the vehicle interior. The rotation speed (that is, blowing capability) of the indoor blower 52 is controlled by a control voltage output from the control device 60.

The indoor evaporator 18 and the heater core 32 are arranged on the ventilation air flow downstream side of the indoor blower 52. The indoor evaporator 18 is provided on the ventilation air flow upstream side of the heater core 32. A cold air bypass passage 55 through which the ventilation air having passed through the indoor evaporator 18 flows while bypassing the heater core 32 is formed in the air conditioning case 51.

An air mix door 54 is provided on the ventilation air flow downstream side of the indoor evaporator 18 in the air conditioning case 51 and on the ventilation air flow upstream side of the heater core 32 and the cold air bypass passage 55 in the air conditioning case 51.

The air mix door 54 adjusts the air volume ratio between the air volume of the ventilation air passing through the heater core 32 and the air volume of the ventilation air passing through the cold air bypass passage 55 in the ventilation air having passed through the indoor evaporator 18. Operation of an actuator for driving the air mix door 54 is controlled by a control signal output from the control device 60.

A mixing space 56 is formed on the ventilation air flow downstream side of the heater core 32 and the cold air bypass passage 55. The mixing space 56 is a space where the ventilation air heated by the heater core 32 and the ventilation air that has passed through the cold air bypass passage 55 and has not been heated are mixed.

Therefore, in the indoor air conditioning unit 50, by adjusting the opening of the air mix door 54, the temperature of the ventilation air (that is, conditioned air) mixed in the mixing space 56 and blown into the vehicle interior can be adjusted. The air mix door 54 of the present embodiment is an air flow rate regulating unit that regulates the flow rate of the ventilation air subjected to heat exchange at the heater core 32.

A plurality of opening holes (not illustrated) for blowing conditioned air to various locations in the vehicle interior are formed at the most downstream portion of the ventilation air flow in the air conditioning case 51. A blowing mode door (not illustrated) that opens and closes each opening hole is provided in each of the plurality of opening holes. Operation of an actuator for driving the blowing mode door is controlled by a control signal output from the control device 60.

Therefore, in the indoor air conditioning unit 50, by switching the openings which are opened and closed by the blowing mode door, the air-conditioned air which is adjusted to a proper temperature can be blown to proper places in the vehicle interior.

Next, an electric control unit of the present embodiment will be described. The control device 60 includes a known microcontroller including a central processing device (i.e., CPU), a read only memory (i.e., ROM), a random access memory (i.e., RAM), and peripheral circuits thereof. The control device 60 performs various calculations and processes based on a control program stored in the ROM. The control device 60 then controls the operations of the various control target devices 11, 14a to 14d, 22a, 22b, 31, 41, 52, 53, and the like connected to the output side on the basis of the calculation and processing results.

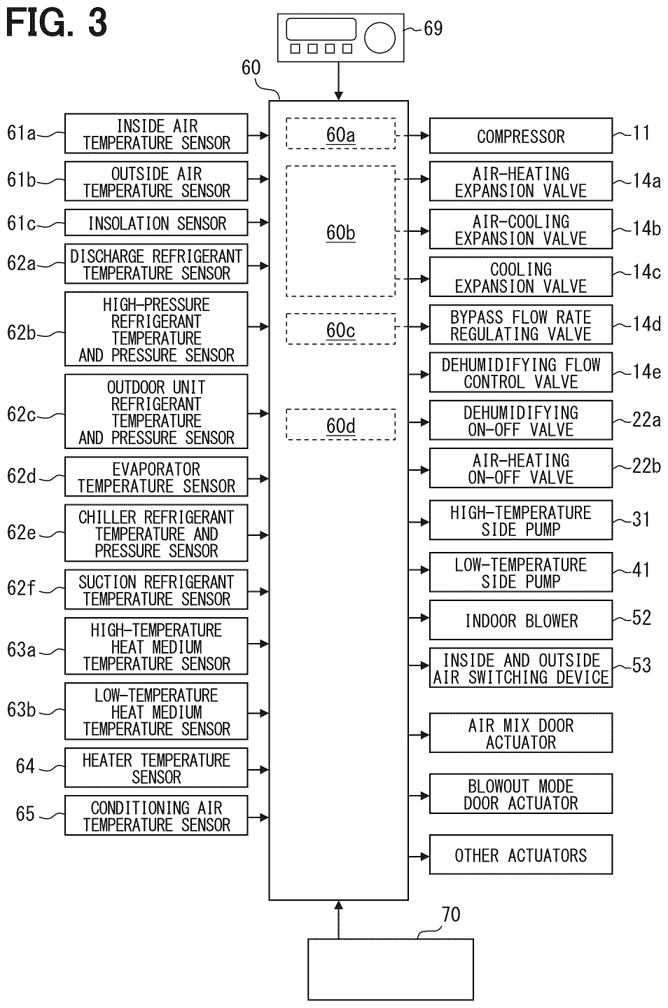

As illustrated in the block diagram of FIG. 3, a control sensor group is connected to the input side of the control device 60. The group of control sensors includes an inside air temperature sensor 61a, an outside air temperature sensor 61b, an insolation sensor 61c, a discharge refrigerant temperature sensor 62a, a high-pressure side refrigerant temperature and pressure sensor 62b, an outdoor unit side refrigerant temperature and pressure sensor 62c, an evaporator temperature sensor 62d, a chiller side refrigerant temperature and pressure sensor 62e, a suction refrigerant temperature sensor 62f, a high-temperature side heat medium temperature sensor 63a, a low-temperature side heat medium temperature sensor 63b, a heater temperature sensor 64, and a conditioning air temperature sensor 65.

The inside air temperature sensor 61a is an inside air temperature detection unit that detects a vehicle interior temperature (an inside air temperature) Tr. The outside air temperature sensor 61b is an outside air temperature detection unit that detects the vehicle outside air temperature (an outside air temperature) Tam. The insolation sensor 61c is an insolation amount detection unit that detects an insolation amount As of insolation irradiated into the vehicle interior.

The discharge refrigerant temperature sensor 62a is a discharge refrigerant temperature detection unit that detects a discharge refrigerant temperature Td of the discharge refrigerant discharged from the compressor 11.

The evaporator temperature sensor 62d is an evaporator temperature detection unit that detects a refrigerant evaporation temperature (an evaporator temperature) Tefin in the indoor evaporator 18. Specifically, the evaporator temperature sensor 62d detects a heat exchange fin temperature of the indoor evaporator 18.

The high-pressure side refrigerant temperature and pressure sensor 62b is a high-pressure side refrigerant temperature-pressure detection unit that detects a high-pressure side refrigerant temperature T1, which is the temperature of the refrigerant flowing out of the water-refrigerant heat exchanger 13, and a discharge refrigerant pressure Pd, which is the pressure of the refrigerant flowing out of the water-refrigerant heat exchanger 13. The discharge refrigerant pressure Pd can be used as the pressure of the discharge refrigerant discharged from the compressor 11.

The outdoor unit side refrigerant temperature and pressure sensor 62c is an outdoor unit side refrigerant temperature and pressure detection unit that detects an outdoor unit side refrigerant temperature T2, which is the temperature of the refrigerant flowing out of the outdoor heat exchanger 15, and an outdoor unit side refrigerant pressure P2, which is the pressure of the refrigerant flowing out of the outdoor heat exchanger 15. Specifically, the temperature and pressure of the refrigerant flowing through the refrigerant passage from the refrigerant outflow port of the outdoor heat exchanger 15 to one inflow port of the third three-way joint 12c are detected.

The chiller-side refrigerant temperature and pressure sensor 62e is a chiller-side refrigerant temperature-pressure detection unit that detects a chiller-side refrigerant temperature Tc, which is the temperature of the refrigerant flowing out of the refrigerant passage in the chiller 20, and a chiller-side refrigerant pressure Pc, which is the pressure of the refrigerant flowing out of the refrigerant passage in the chiller 20. The chiller-side refrigerant pressure Pc can be used as a suction refrigerant pressure Ps that is the pressure of the suction refrigerant sucked into the compressor 11. Therefore, the chiller-side refrigerant temperature and pressure sensor 62e of the present embodiment is a suction pressure detection unit.

In the present embodiment, as the refrigerant temperature and pressure sensor, a detection unit in which the pressure detection unit and the temperature detection unit are integrated is used, but it is needless to mention that the pressure detection unit and the temperature detection unit configured separately may be used.

The suction refrigerant temperature sensor 62f is a suction refrigerant temperature detection unit that is provided in the suction-side passage 21d and detects a suction refrigerant temperature Ts, which is the temperature of the suction refrigerant sucked into the compressor 11.

The high-temperature side heat medium temperature sensor 63a is a high-temperature side heat medium temperature detection unit that detects a high-temperature side heat medium temperature TWH, which is the temperature of the high-temperature side heat medium flowing into the heater core 32. The low-temperature heat medium temperature sensor 63b is a low-temperature heat medium temperature detection unit detecting a low-temperature heat medium temperature TWL as the temperature of the low-temperature heat medium flowing in the cooling water passage 70a of the electric heater 70.

The heater temperature sensor 64 is a battery temperature detection unit that detects a heater temperature TB, which is the temperature of the electric heater 70.

The conditioned air temperature sensor 65 is a conditioned air temperature detection unit that detects a ventilation air temperature TAV of the air blown from the mixing space 56 into the vehicle interior. The ventilation air temperature TAV is an object temperature of the ventilation air as an object to be heated.

As illustrated in FIG. 3, an operation panel 69 provided near the instrument panel at the front part of the vehicle interior is connected to the input side of the control device 60 in a wired or wireless manner. Operation signals from various operation switches provided on the operation panel 69 are input to the control device 60.

Specific examples of the various operation switches provided on the operation panel 69 include an auto switch, an air conditioner switch, an air volume setting switch, and a temperature setting switch.

The auto switch is an automatic control setting unit that sets or cancels the automatic control operation of the vehicular air conditioner 1. The air conditioner switch is a cooling request unit that requests the indoor evaporator 18 to cool ventilation air. The air volume setting switch is an air volume setting unit that manually sets an air blowing volume of the indoor blower 52. The temperature setting switch is a temperature setting portion for setting a set temperature Tset of the vehicle interior.

The control device 60 of the present embodiment is integrally configured with a controller that controls various control target devices connected to an output side thereof. Therefore, a configuration (hardware and software) that controls the operation of each device to be controlled constitutes a controller that controls the operation of each device to be controlled.

For example, in the control device 60, the configuration that controls the refrigerant discharge capability of the compressor 11 configures a discharge capability control unit 60a.

The discharge capacity control unit 60a controls the refrigerant discharge capacity of the compressor 11 so that the rotation speed of the compressor 11 does not exceed a maximum rotation speed and an upper limit rotation speed. The maximum rotation speed is determined based on the durability of the compressor 11. The upper limit rotation speed is a rotation speed that is determined based on an allowable noise level of the compressor 11. That is, since the noise of the compressor 11 increases as the rotation speed of the compressor 11 increases, the rotation speed of the compressor 11 at which the noise of the compressor 11 reaches the allowable noise level is set as the upper limit rotation speed. Therefore, the discharge capacity control unit 60a also functions as an upper limit rotation speed determination unit that determines the upper limit rotation speed of the compressor 11.

The configuration of controlling the operation of the heating-unit side decompression unit (in the present embodiment, the air-heating expansion valve 14a and the air-cooling expansion valve 14b, and the cooling expansion valve 14c) configures a heating-unit side control unit 60b. The configuration of controlling the operation of the bypass-side flow rate regulating valve 14d configures a bypass-side control unit 60c. The target heating capacity determination unit 60d determines a target heating capacity (in other words, the target heating capacity) in the indoor air conditioning unit 50. For example, a target high-temperature side heat medium temperature (TWHO) is determined.

Next, the operation of the vehicular air conditioner 1 according to the present embodiment in the above configuration will be described. In the vehicular air conditioner of the present embodiment, various operation modes are switched in order to perform air conditioning of the vehicle interior. Switching of the operation mode is performed by executing a control program stored in advance in the control device 60. Various operation modes will be described below.

First, an operation mode in which the refrigerant does not flow through the bypass passage 21c will be described. The operation modes in which the refrigerant is not circulated through the bypass passage 21c include (a) an air-cooling mode, (b) a series dehumidifying air-heating mode, (c) an outside air heat absorbing air-heating mode, and (d) a heater heat absorbing air-heating mode.

### (a) Air-Cooling Mode

The air-cooling mode is an operation mode in which the air in the vehicle interior is cooled by blowing cooled ventilation air into the vehicle interior. In the control program, the air-cooling mode is selected mainly in summer when the outside air temperature Tam is relatively high (25° C. or higher in the present embodiment).

In the heat pump cycle 10 in the air-cooling mode, the control device 60 brings the air-heating expansion valve 14a into a fully open state, brings the air-cooling expansion valve 14b into a throttled state that exhibits the refrigerant decompression action, brings the cooling expansion valve 14c into a fully closed state, and brings the bypass-side flow rate regulating valve 14d into the fully closed state. In addition, the control device 60 closes the dehumidifying on-off valve 22a and also closes the air-heating on-off valve 22b.

Therefore, in the heat pump cycle 10 in the air-cooling mode, the refrigerant circuit is switched to a refrigerant circuit in which the refrigerant discharged from the compressor 11 circulates through the water-refrigerant heat exchanger 13, the air-heating expansion valve 14a in the fully open state, the outdoor heat exchanger 15, the air-cooling expansion valve 14b in the throttled state, the indoor evaporator 18, the suction-side passage 21d, and the suction port of the compressor 11 in this order.

The control device 60 controls the refrigerant discharge performance of the compressor 11 in such a manner that the evaporator temperature Tefin detected by the evaporator temperature sensor 62d approaches a target evaporator temperature TEO. The target evaporator temperature TEO is determined, based on the target blowout temperature TAO, with reference to the controlling map stored in the control device 60 in advance.

The target blowout temperature TAO is a target temperature of ventilation air to be blown into the vehicle interior. The target blowout temperature TAO is calculated using the inside air temperature Tr detected by the inside air temperature sensor 61a, the outside air temperature Tam, the insolation amount As detected by the insolation sensor 61c, the set temperature Tset set by the temperature setting switch, and the like. In the control map, it is determined that the target evaporator temperature TEO increases as the target blowout temperature TAO increases.

The degree of superheating SH of the suction refrigerant can be determined using the chiller-side refrigerant pressure Pc detected by the chiller-side refrigerant temperature and pressure sensor 62e and the suction refrigerant temperature Ts detected by the suction refrigerant temperature sensor 62f.

In the high-temperature side heat medium circuit 30 in the air-cooling mode, the control device 60 operates the high-temperature side pump 31 so as to exhibit a predetermined reference pumping capability. Therefore, in the high-temperature side heat medium circuit 30 in the air-cooling mode, the heat medium pumped from the high-temperature side pump 31 circulates through the heat medium passage of the water-refrigerant heat exchanger 13, the heater core 32, and the suction port of the high-temperature side pump 31 in this order.

In the indoor air conditioning unit 50 in the air-cooling mode, the control device 60 controls the blowing capacity of the indoor blower 52 with reference to a control map stored in advance in the control device 60 based on the target blowout temperature TAO. The control device 60 adjusts the opening of the air mix door 54 such that the ventilation air temperature TAV detected by the conditioned air temperature sensor 65 approaches the target blowout temperature TAO. Furthermore, the control device 60 appropriately controls the operations of the other control target devices.

Therefore, in the heat pump cycle 10 in the air-cooling mode, a vapor compression refrigeration cycle is configured in which the water-refrigerant heat exchanger 13 and the outdoor heat exchanger 15 function as condensers that radiate heat of the refrigerant and condense the refrigerant, and the indoor evaporator 18 functions as an evaporator that evaporates the refrigerant.

In the high-temperature side heat medium circuit 30 in the air-cooling mode, the high-temperature side heat medium heated by the water-refrigerant heat exchanger 13 flows into the heater core 32.

In the indoor air conditioning unit 50 in the air-cooling mode, the ventilation air supplied by the indoor blower 52 is cooled by the indoor evaporator 18. The ventilation air cooled by the indoor evaporator 18 is reheated by the heater core 32 so as to approach the target blowout temperature TAO based on the opening of the air mix door 54. The ventilation air with a regulated temperature is blown into the vehicle interior, so that the air in the vehicle interior is cooled.

### (b) Series Dehumidifying Air-Heating Mode

The series dehumidifying air-heating mode is an operation mode in which the air in the vehicle interior is dehumidified and heated by reheating cooled and dehumidified ventilation air and blowing the reheated ventilation air into the vehicle interior. In the control program, the series dehumidifying air-heating mode is selected when the outside air temperature Tam is a temperature in a predetermined medium to high temperature range (equal to or higher than 10° C. and lower than 25° C. in the present embodiment).

In the heat pump cycle 10 in the series dehumidifying air-heating mode, the control device 60 brings the air-heating expansion valve 14a into the throttled state, brings the air-cooling expansion valve 14b into the throttled state, brings the cooling expansion valve 14c into the fully closed state, and brings the bypass-side flow rate regulating valve 14d into the fully closed state. In addition, the control device 60 closes the dehumidifying on-off valve 22a and also closes the air-heating on-off valve 22b.

Therefore, in the heat pump cycle 10 in the series dehumidifying air-heating mode, the refrigerant circuit is switched to a refrigerant circuit in which the refrigerant discharged from the compressor 11 circulates through the water-refrigerant heat exchanger 13, the air-heating expansion valve 14a in the throttled state, the outdoor heat exchanger 15, the air-cooling expansion valve 14b in the throttled state, the indoor evaporator 18, the suction-side passage 21d, and the suction port of the compressor 11 in this order.

In addition, the control device 60 controls the throttle opening of the air-heating expansion valve 14a and the throttle opening of the air-cooling expansion valve 14b with reference to the control map stored in advance in the control device 60. In the control map, the throttle opening of the air-heating expansion valve 14a and the throttle opening of the air-cooling expansion valve 14b are determined in such a manner that the degree of superheating SH of the suction refrigerant approaches the reference degree of superheating KSH.

In the high-temperature side heat medium circuit 30 in the series dehumidifying air-heating mode, the control device 60 operates the high-temperature side pump 31 as in the air-cooling mode.

In the indoor air conditioning unit 50 in the series dehumidifying air-heating mode, the control device 60 controls the ventilation performance of the indoor blower 52 and the opening of the air mix door 54 as in the air-cooling mode. Furthermore, the control device 60 appropriately controls the operations of the other control target devices.

Therefore, in the heat pump cycle 10 in the series dehumidifying air-heating mode, a vapor compression refrigeration cycle is configured in which the water-refrigerant heat exchanger 13 functions as a condenser, and the indoor evaporator 18 functions as an evaporator.

In addition, in the series dehumidifying air-heating mode, in a case where the saturation temperature of the refrigerant in the outdoor heat exchanger 15 is higher than the outside air temperature Tam, the outdoor heat exchanger 15 functions as a condenser. In a case where the saturation temperature of the refrigerant in the outdoor heat exchanger 15 is lower than the outside air temperature Tam, the outdoor heat exchanger 15 functions as an evaporator.

In the high-temperature side heat medium circuit 30 in the series dehumidifying air-heating mode, the high-temperature side heat medium heated by the water-refrigerant heat exchanger 13 flows into the heater core 32.

In the indoor air conditioning unit 50 in the series dehumidifying air-heating mode, the ventilation air supplied by the indoor blower 52 is cooled and dehumidified by the indoor evaporator 18. The ventilation air cooled and dehumidified by the indoor evaporator 18 is reheated by the heater core 32 so as to approach the target blowout temperature TAO based on the opening of the air mix door 54. The ventilation air with a regulated temperature is blown into the vehicle interior, so that the air in the vehicle interior is dehumidified and heated.

### (c) Outside Air Heat Absorbing Air-Heating Mode

The outside air heat absorbing air-heating mode is an operation mode in which the vehicle interior is heated by blowing heated ventilation air into the vehicle interior. In the control program, the outside air heat absorbing air-heating mode is selected mainly in winter when the outside air temperature Tam is relatively low (equal to or higher than −10° C. and lower than 0° C. in the present embodiment).

In the heat pump cycle 10 in the outside air heat absorbing air-heating mode, the control device 60 brings the air-heating expansion valve 14a into the throttled state, brings the air-cooling expansion valve 14b into the fully closed state, brings the cooling expansion valve 14c into the fully closed state, and brings the bypass-side flow rate regulating valve 14d into the fully closed state. In addition, the control device 60 closes the dehumidifying on-off valve 22a and also closes the air-heating on-off valve 22b.

Therefore, in the heat pump cycle 10 in the outside air heat absorbing air-heating mode, the refrigerant circuit is switched to a refrigerant circuit in which the refrigerant discharged from the compressor 11 circulates through the water-refrigerant heat exchanger 13, the air-heating expansion valve 14a in the throttled state, the outdoor heat exchanger 15, the air-heating passage 21b, the suction-side passage 21d, and the suction port of the compressor 11 in this order.

In addition, the control device 60 controls the refrigerant discharge performance of the compressor 11 in such a manner that the discharge refrigerant pressure Pd detected by the high-pressure side refrigerant temperature and pressure sensor 62b approaches a target high pressure PDO. The target high pressure PDO is determined based on the target blowout temperature TAO with reference to a control map stored in advance in the control device 60. In the control map, the target high pressure PDO is determined to be increased as the target blowout temperature TAO increases.

The control device 60 also controls the throttle opening of the air-heating expansion valve 14a in a manner that the degree of superheating SH of the suction refrigerant approaches the reference degree of superheating KSH.

In the high-temperature side heat medium circuit 30 in the outside air heat absorbing air-heating mode, the control device 60 operates the high-temperature side pump 31 as in the air-cooling mode.

In the indoor air conditioning unit 50 in the outside air heat absorbing air-heating mode, the control device 60 controls the blowing capacity of the indoor blower 52 and the opening of the air mix door 54 as in the air-cooling mode. Furthermore, the control device 60 appropriately controls the operations of the other control target devices.

Therefore, in the heat pump cycle 10 in the outside air heat absorbing air-heating mode, a vapor compression refrigeration cycle is configured in which the water-refrigerant heat exchanger 13 functions as a condenser and the outdoor heat exchanger 15 functions as an evaporator.

In the outside air heat absorbing air-heating mode, the high-temperature side heat medium heated by the water-refrigerant heat exchanger 13 flows into the heater core 32 as in the air-cooling mode.

In the indoor air conditioning unit 50 in the outside air heat absorbing air-heating mode, the ventilation air blown from the indoor blower 52 passes through the indoor evaporator 18. The ventilation air having passed through the indoor evaporator 18 is heated by the heater core 32 so as to approach the target blowout temperature TAO depending on the opening of the air mix door 54. The ventilation air whose temperature has been adjusted is blown into the vehicle interior, so that the vehicle interior is heated.

### (d) Heater Heat Absorbing Air-Heating Mode

The heater heat absorbing air-heating mode is an operation mode in which heat generated by the electric heater 70 is used as a heat source to blow heated air into the vehicle interior, thereby heating the vehicle interior. In the control program, the outside air heat absorbing air-heating mode is selected mainly in winter when the outside air temperature Tam is relatively low (equal to or higher than −10° C. and lower than 0° C. in the present embodiment).

In the heat pump cycle 10 in the heater heat absorbing air-heating mode, the control device 60 brings the air-heating expansion valve 14a into the fully closed state, brings the air-cooling expansion valve 14b into the fully closed state, brings the cooling expansion valve 14c into the throttled state, and brings the bypass-side flow rate regulating valve 14d into the fully closed state. In addition, the control device 60 closes the dehumidifying on-off valve 22a and also closes the air-heating on-off valve 22b.

For this reason, in the heat pump cycle 10 in the heater heat absorbing air-heating mode, the refrigerant circuit is switched to a refrigerant circuit in which a refrigerant discharged from the compressor 11 circulates through the water refrigerant heat exchanger 13, the throttled cooling expansion valve 14c, the chiller 20, the suction-side passage 21d and the suction port of the compressor 11 in this order.

In addition, the control device 60 controls the refrigerant discharge performance of the compressor 11 in such a manner that the discharge refrigerant pressure Pd detected by the high-pressure side refrigerant temperature and pressure sensor 62b approaches a target high pressure PDO. The target high pressure PDO is determined based on the target blowout temperature TAO with reference to a control map stored in advance in the control device 60. In the control map, the target high pressure PDO is determined to be increased as the target blowout temperature TAO increases.

The control device 60 may control the refrigerant discharge capacity of the compressor 11 so that the high-temperature side heat medium temperature TWH detected by the high-temperature side heat medium temperature sensor 63a approaches the target high-temperature side heat medium temperature TWHO. The target high-temperature side heat medium temperature TWHO is determined based on the target blowout temperature TAO with reference to a control map stored in advance in the control device 60. In the control map, a target high-temperature side heat medium temperature TWHO is determined to be increased as the target blowout temperature TAO increases. The target high-temperature side heat medium temperature TWHO is an index indicating a target heating capacity (in other words, target air-heating capacity) in the water-refrigerant heat exchanger 13 (in other words, the heater core 32).

The control device 60 also controls the throttle opening of the air-heating expansion valve 14a in a manner that the degree of superheating SH of the suction refrigerant approaches the reference degree of superheating KSH.

In the high-temperature side heat medium circuit 30 in the heater air heat absorbing air-heating mode, the control device 60 operates the high-temperature side pump 31 as in the single air-cooling mode.

In the indoor air conditioning unit 50 in the heater heat absorbing air-heating mode, the control device 60 controls the blowing capacity of the indoor blower 52 and the opening of the air mix door 54 as in the air-cooling mode. Furthermore, the control device 60 appropriately controls the operations of the other control target devices.

Therefore, in the heat pump cycle 10 in the heater heat absorbing air-heating mode, a vapor compression refrigeration cycle is configured in which the water-refrigerant heat exchanger 13 functions as a condenser and the chiller 20 functions as an evaporator.

In the heater heat absorbing air-heating mode, the high-temperature side heat medium heated by the water-refrigerant heat exchanger 13 flows into the heater core 32 as in the air-cooling mode.

In the indoor air conditioning unit 50 in the heater heat absorbing air-heating mode, the ventilation air blown from the indoor blower 52 passes through the indoor evaporator 18. The ventilation air having passed through the indoor evaporator 18 is heated by the heater core 32 so as to approach the target blowout temperature TAO depending on the opening of the air mix door 54. The ventilation air whose temperature has been adjusted is blown into the vehicle interior, so that the vehicle interior is heated.

In the low-temperature side heat medium circuit 40 in the heater heat absorbing air-heating mode, the low-temperature side heat medium that has been heated by flowing through the cooling water passage 70a of the electric heater 70 absorbs heat in the chiller 20. As a result, the heat generated by the electric heater 70 can be effectively used to heat the blown air, thereby achieving heating of the vehicle interior.

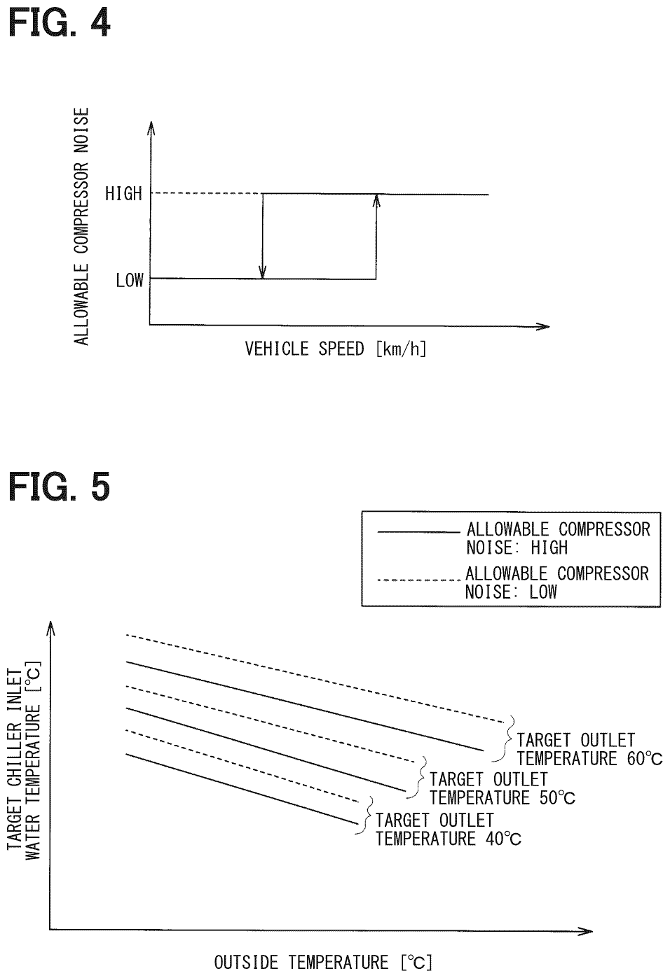

Herein, the control of the electric heater 70 in the heater heat absorbing air-heating mode will be described. The control device 60 determines the allowable noise level of the compressor 11 based on the vehicle speed and with reference to the control map shown in FIG. 4. Specifically, when the vehicle speed is higher than a predetermined value, the allowable noise level of the compressor 11 is determined to be high, and when the vehicle speed is lower than the predetermined value, the allowable noise level of the compressor 11 is determined to be low. This is because when the vehicle speed is high, the noise of the compressor 11 is easily drowned out by the traveling noise.

When the allowable noise level of the compressor 11 is high, the control device 60 determines the upper limit rotation speed of the compressor 11 to be a first upper limit rotation speed NcImt1, and when the allowable noise level of the compressor 11 is low, the control device 60 determines the upper limit rotation speed of the compressor 11 to be a second upper limit rotation speed NcImt2 which is smaller than the first upper limit rotation speed NcImt1.

The control device 60 determines a target chiller inlet water temperature TWO based on the allowable noise level of the compressor 11 and a required heating capacity. Specifically, the target chiller inlet water temperature TWO is determined based on the allowable noise level of the compressor 11, the outside air temperature, and the target blowout temperature TAO and with reference to the control map shown in FIG. 5.

Specifically, the greater the required heating capacity (e.g., the lower the outside air temperature, the higher the target blowout temperature TAO, the lower the intake air temperature of the indoor air conditioning unit 50, etc.), the higher the target chiller inlet water temperature TWO is set. In addition, the smaller the required heating capacity (e.g., the higher the outside air temperature, the lower the target blowout temperature TAO), the lower the target chiller inlet water temperature TWO is set.

Furthermore, when the allowable noise level of the compressor 11 is low, the target chiller inlet water temperature TWO is set higher than that when the allowable noise level of the compressor 11 is high.

The control device 60 controls the power supplied to the electric heater 70 (in other words, the amount of heat generated by the electric heater 70) so that the chiller inlet water temperature TW approaches the target chiller inlet water temperature TWO. Specifically, when the chiller inlet water temperature TW is lower than the target chiller inlet water temperature TWO, the power supplied to the electric heater 70 (in other words, the amount of heat generated by the electric heater 70) is increased, and when the chiller inlet water temperature TW is higher than the target chiller inlet water temperature TWO, the power supplied to the electric heater 70 (in other words, the amount of heat generated by the electric heater 70) is decreased.

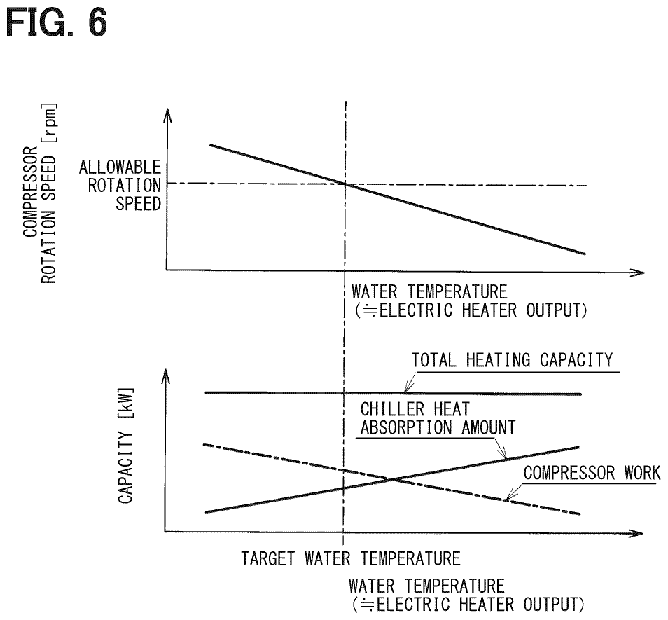

As a result, as shown in FIG. 6, the amount of heat absorbed in the chiller 20 increases or decreases depending on the chiller inlet water temperature TW, and the amount of work of the compressor 11 (in other words, the rotation speed of the compressor 11) increases or decreases in a manner opposite to the amount of heat absorbed in the chiller 20, thereby achieving the desired heating capacity. Specifically, as the chiller inlet water temperature TW increases, the amount of heat absorbed in the chiller 20 increases, and the amount of work of the compressor 11 (in other words, the rotation speed of the compressor 11) decreases.

As a result, when the allowable noise level of the compressor 11 is low, the rotation speed of the compressor 11 can be kept low to keep the noise of the compressor 11 low. Moreover, since the rotation speed of the compressor 11 can be brought as close as possible to the allowable rotation speed, the rotation speed of the compressor 11 can be prevented from becoming too low. Therefore, it is possible to prevent the amount of heat absorbed by the chiller 20 from becoming too large, resulting in increase in the heat loss.

Next, an operation mode in which the refrigerant flows through the bypass passage 21c will be described. Examples of the operation mode in which the refrigerant flows through the bypass passage 21c include (d) hot gas air-heating mode, (e) hot gas dehumidifying air-heating mode, and (f) hot-gas series dehumidifying air-heating mode.

### (e) Hot Gas Air-Heating Mode

The hot gas air-heating mode is an operation mode for heating the vehicle interior. In the control program, the hot gas air-heating mode is selected when the outside air temperature Tam is extremely low (lower than −10° C. in the present embodiment) or when it is determined that the heating performance of the ventilation air in the water-refrigerant heat exchanger 13 is insufficient in the outside air heat absorbing air-heating mode.

In the control program, when the ventilation air temperature TAV is lower than the target blowout temperature TAO, it is determined that the heating performance of the ventilation air is insufficient. The same applies to other operation modes.

Examples of the hot gas air-heating mode include a single hot gas air-heating mode and a heater heat absorbing hot gas air-heating mode. The single hot gas air-heating mode is an operation mode in which the air in the vehicle interior is heated without absorbing heat of the electric heater 70. The heater heat absorbing hot gas air-heating mode is an operation mode in which heat is absorbed from the electric heater 70 to heat the vehicle interior.

(e-1) Single Hot Gas Air-Heating Mode

In the heat pump cycle 10 in the single hot gas air-heating mode, the control device 60 brings the air-heating expansion valve 14a into the fully closed state, brings the air-cooling expansion valve 14b into the fully closed state, brings the cooling expansion valve 14c into the throttled state, and brings the bypass-side flow rate regulating valve 14d into the throttled state. The control device 60 opens the dehumidifying on-off valve 22a and closes the air-heating on-off valve 22b.

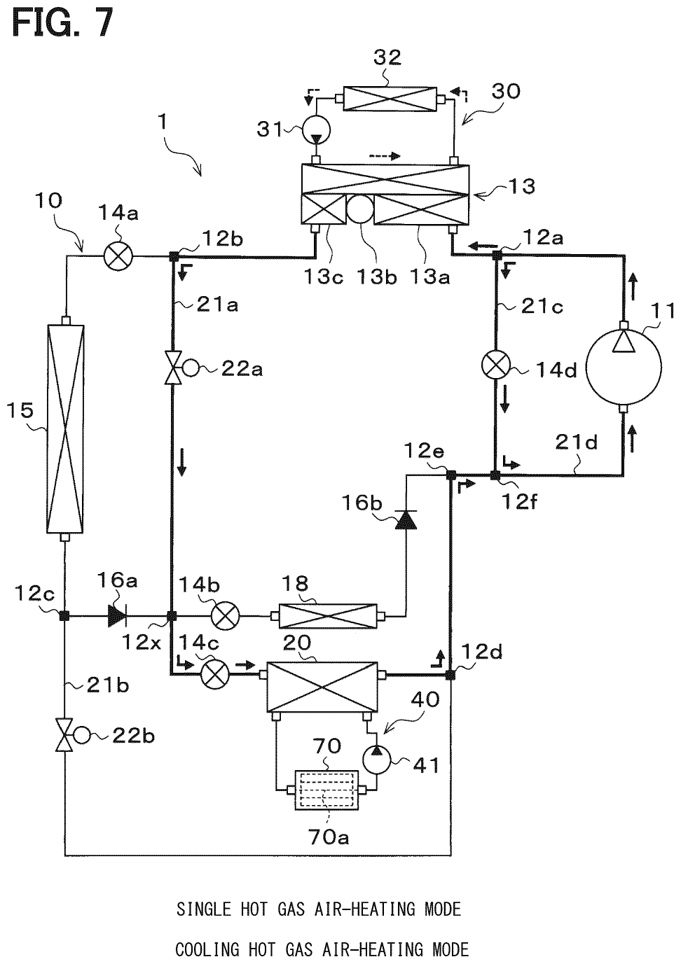

Therefore, in the heat pump cycle 10 in the single hot gas air-heating mode, as indicated by solid arrows in FIG. 7, the refrigerant discharged from the compressor 11 circulates through the first three-way joint 12a, the water-refrigerant heat exchanger 13, the dehumidifying passage 21a, the cooling expansion valve 14c in the throttled state, the chiller 20, the suction-side passage 21d, and the suction port of the compressor 11 in this order. At the same time, the refrigerant circuit is switched to a refrigerant circuit in which the refrigerant discharged from the compressor 11 circulates through the first three-way joint 12a, the bypass-side flow rate regulating valve 14d in the throttled state, which is provided in the bypass passage 21c, the suction-side passage 21d, and the suction port of the compressor 11 in this order.

Furthermore, the control device 60 controls the refrigerant discharge performance of the compressor 11 in such a manner that the chiller-side refrigerant pressure Pc approaches a predetermined first target low pressure PSO1.

Controlling the chiller-side refrigerant pressure Pc corresponding to the suction refrigerant pressure Ps so as to approach a constant pressure is effective for stabilizing a discharge flow rate Gr (the mass flow rate) of the compressor 11. More specifically, by generating a saturated gas-phase refrigerant with a constant pressure as the suction refrigerant pressure Ps, the density of the suction refrigerant becomes constant. Therefore, when the suction refrigerant pressure Ps is controlled to approach a constant pressure, the discharge flow rate Gr of the compressor 11 at the same rotation speed is easily stabilized.

The control device 60 controls the throttle opening of the bypass-side flow rate regulating valve 14d such that the discharge refrigerant pressure Pd approaches the target high pressure PDO.

The control device 60 also controls the throttle opening of the cooling expansion valve 14c in a manner that the degree of superheating SH of the suction refrigerant approaches the reference degree of superheating KSH.

In the high-temperature side heat medium circuit 30 in the single hot gas air-heating mode, the control device 60 operates the high-temperature side pump 31 as in the single air-cooling mode.

In the low-temperature side heat medium circuit 40 in the single hot gas air-heating mode, the control device 60 stops the low-temperature side pump 41.

In the indoor air conditioning unit 50 in the single hot gas air-heating mode, the control device 60 controls the opening degree of the air mix door 54, similarly in the single air conditioning mode. In the hot gas air-heating mode, the opening of the air mix door 54 is often controlled such that almost the entire volume of ventilation air blown from the indoor blower 52 passes through the heater core 32.

The control device 60 controls the operation of the inside air and inside and outside air switching device 53 so as to introduce inside air into the air conditioning case 51. Furthermore, the control device 60 appropriately controls the operations of the other control target devices.

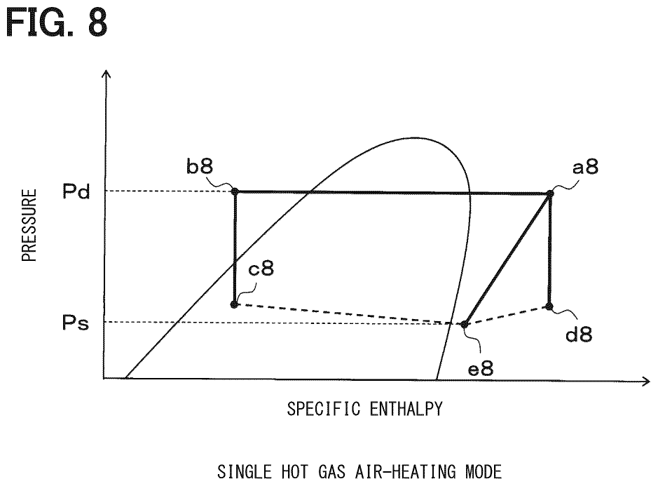

Therefore, in the heat pump cycle 10 in the single hot gas air-heating mode, the state of the refrigerant changes as illustrated in the Mollier chart of FIG. 8.

First, the flow of the discharge refrigerant (point a8 in FIG. 8) discharged from the compressor 11 is branched at the first three-way joint 12a. One of the refrigerant divided at the first three-way joint 12a flows into the water-refrigerant heat exchanger 13 and radiates heat to the high-temperature side heat medium (from point a8 to point b8 in FIG. 8). As a result, the high-temperature side heat medium is heated.

The refrigerant flowing out of the water-refrigerant heat exchanger 13 flows into the dehumidifying passage 21a. The refrigerant that has flown into the dehumidifying passage 21a flows into the cooling expansion valve 14c and is decompressed (from point b8 to point c8 in FIG. 8).

The refrigerant depressurized at the cooling expansion valve 14c flows into the chiller 20. In the hot gas air-heating mode, since the low-temperature side pump 41 is stopped, the chiller 20 does not exchange heat between the refrigerant and the low-temperature side heat medium. The refrigerant flowing out of the chiller 20 flows into the other inflow port of the sixth three-way joint 12f via the fourth three-way joint 12d and the fifth three-way joint 12e.

The other refrigerant branched at the first three-way joint 12a flows into the bypass passage 21c. The refrigerant flowing into the bypass passage 21c is decompressed when the flow rate is regulated by the bypass-side flow rate regulating valve 14d (from point a8 to point d8 in FIG. 8). The refrigerant depressurized at the bypass-side flow rate regulating valve 14d flows into one inflow port of the sixth three-way joint 12f.

The refrigerant flowing out of the chiller 20 and the refrigerant flowing out of the bypass-side flow rate regulating valve 14d are joined and mixed at the sixth three-way joint 12f. The refrigerant flowing out of the sixth three-way joint 12f is mixed when flowing through the suction-side passage 21d (point e8 in FIG. 8), and is drawn into the compressor 11.

As described above, in the heat pump cycle 10 in the hot gas air-heating mode, refrigerants with different enthalpies, such as the low-enthalpy refrigerant flowing out of the chiller 20 (point c8 in FIG. 8) and the high-enthalpy refrigerant flowing out of the bypass passage 21c (point d8 in FIG. 8), are mixed and drawn into the compressor 11.

Therefore, in the heat pump cycle 10 in the hot gas air-heating mode, the cooling expansion valve 14c serves as the heating-unit side decompression unit.

In the high-temperature side heat medium circuit 30 in the hot gas air-heating mode, the high-temperature side heat medium heated by the water-refrigerant heat exchanger 13 flows into the heater core 32 as in the single air-cooling mode.

As in the outside air heat absorbing air-heating mode, the indoor air conditioning unit 50 in the single hot gas air-heating mode blows temperature-regulated ventilation air into the vehicle interior to achieve heating of the vehicle interior.

Here, the single hot gas air-heating mode is an operation mode performed when the outside air temperature Tam is extremely low. For this reason, when the refrigerant flowing out of the water-refrigerant heat exchanger 13 flows into the outdoor heat exchanger 15, the refrigerant may radiate heat to the outside air in outdoor heat exchanger 15. When the refrigerant radiates heat to the outside air in the outdoor heat exchanger 15, the amount of heat by which the refrigerant radiates to the ventilation air in the water-refrigerant heat exchanger 13 decreases, and the heating performance of the ventilation air decreases accordingly.

In the single hot gas air-heating mode of the present embodiment, since the refrigerant circuit is switched to the refrigerant circuit that does not allow the refrigerant flowing out of the water-refrigerant heat exchanger 13 to flow into the outdoor heat exchanger 15, it is possible to prevent the refrigerant from radiating heat to the outside air in the outdoor heat exchanger 15.

In the single hot gas air-heating mode of the present embodiment, the throttle opening of the cooling expansion valve 14c is controlled in a manner that the degree of superheating SH of the suction refrigerant approaches the reference degree of superheating KSH. As a result, by increasing the refrigerant discharge performance of the compressor 11, the state of the suction refrigerant (point e8 in FIG. 8) can be the gas-phase refrigerant with the degree of superheating even if the amount of heat radiated from the discharge refrigerant to the high-temperature side heat medium in the water-refrigerant heat exchanger 13 is increased.

Therefore, in the single hot gas air-heating mode, even when the outside air temperature Tam is extremely low, the heat generated by the amount of work of the compressor 11 can be effectively used to heat the ventilation air, and the air in the vehicle interior can be heated.

(e-2) Heater Heat Absorbing Hot Gas Air-Heating Mode

In the heater heat absorbing hot gas air-heating mode, the control device 60 operates the low-temperature side pump 41 of the low-temperature side heat medium circuit 40 so as to exhibit the predetermined reference pumping performance, as compared with the single hot gas air-heating mode. Therefore, in the heat pump cycle 10 in the heater heat absorbing hot gas air-heating mode, the refrigerant flowing into the chiller 20 absorbs heat from the low-temperature side heat medium. Due to this, the low temperature side heat medium is cooled. The other operations are similar to those in the single hot gas air-heating mode.

Therefore, in the heater heat absorbing hot gas air-heating mode, the heat generated by the amount of work of the compressor 11 can be effectively used to heat the ventilation air, and the air in the vehicle interior can be heated, as in the single hot gas air-heating mode. Furthermore, in the low-temperature side heat medium circuit 40 in the heater heat absorbing hot gas air-heating mode, the low-temperature side heat medium that has been heated by flowing through the cooling water passage 70a of the electric heater 70 absorbs heat in the chiller 20. As a result, the heat generated by the electric heater 70 can be effectively used to heat the blown air, thereby achieving heating of the vehicle interior.

In the heater heat absorbing hot gas heating mode, the control device 60 operates the electric heater 70 in the same manner as in the heater heat absorbing heating mode. As a result, similarly to the heater heat absorbing air-heating mode, when the allowable noise level of the compressor 11 is low, the rotation speed of the compressor 11 can be kept low to keep the noise of the compressor 11 low. Moreover, since the rotation speed of the compressor 11 can be brought as close as possible to the allowable rotation speed, the rotation speed of the compressor 11 can be prevented from becoming too low. Therefore, it is possible to prevent the amount of heat absorbed by the chiller 20 from becoming too large, resulting in increase in the heat loss.

### (f) Hot Gas Dehumidifying Air-Heating Mode

The hot gas dehumidifying air-heating mode is an operation mode in which the air in the vehicle interior is dehumidified and heated. In the control program, the hot gas dehumidifying air-heating mode is selected when the outside air temperature Tam is a temperature in a predetermined low to medium temperature range (equal to or higher than 0° C. and lower than 10° C. in the present embodiment).

In the heat pump cycle 10 in the hot gas dehumidifying air-heating mode, the control device 60 brings the air-heating expansion valve 14a into the fully closed state, brings the air-cooling expansion valve 14b into the throttled state, brings the cooling expansion valve 14c into the throttled state, and brings the bypass-side flow rate regulating valve 14d into the throttled state. The control device 60 opens the dehumidifying on-off valve 22a and closes the air-heating on-off valve 22b.

Therefore, in the heat pump cycle 10 in the hot gas dehumidifying air-heating mode, the refrigerant discharged from the compressor 11 circulates similarly to the single hot gas air-heating mode. At the same time, the refrigerant circuit is switched to a refrigerant circuit in which the refrigerant discharged from the compressor 11 circulates through the first three-way joint 12a, the water-refrigerant heat exchanger 13, the dehumidifying passage 21a, the air-cooling expansion valve 14b in the throttled state, the indoor evaporator 18, the suction-side passage 21d, and the suction port of the compressor 11 in this order. That is, the refrigerant circuit is switched to a refrigerant circuit in which the indoor evaporator 18 and the chiller 20 are connected in parallel to the refrigerant flow.

Furthermore, the control device 60 controls the refrigerant discharge performance of the compressor 11 in a manner that the suction refrigerant pressure Ps approaches a predetermined second target low pressure PSO2. The second target low pressure PSO2 is determined in a manner that the refrigerant evaporating temperature in the indoor evaporator 18 is a temperature at which the ventilation air can be dehumidified without causing frosting on the indoor evaporator 18.

In addition, the control device 60 controls the throttle opening of the bypass-side flow rate regulating valve 14d in a manner that the discharge refrigerant pressure Pd approaches the target high pressure PDO, as in the hot gas air-heating mode.

The control device 60 controls the throttle opening of the air-cooling expansion valve 14b to a predetermined throttle opening for the hot gas dehumidifying air-heating mode.

The control device 60 also controls the throttle opening of the cooling expansion valve 14c in a manner that the degree of superheating SH of the suction refrigerant approaches the reference degree of superheating KSH.

In the high-temperature side heat medium circuit 30 in the hot gas dehumidifying air-heating mode, the control device 60 operates the high-temperature side pump 31 as in the air-cooling mode.

In the low-temperature side heat medium circuit 40 in the hot gas dehumidifying air-heating mode, the control device 60 stops the low-temperature side pump 41.

In the indoor air conditioning unit 50 in the hot gas dehumidifying air-heating mode, the control device 60 controls the ventilation performance of the indoor blower 52 and the opening of the air mix door 54 as in the air-cooling mode. Furthermore, the control device 60 appropriately controls the operations of the other control target devices.

Therefore, in the heat pump cycle 10 in the hot gas dehumidifying air-heating mode, the state of the refrigerant changes as follows.

The flow of the discharge refrigerant discharged from the compressor 11 is branched at the first three-way joint 12a. One of the refrigerant divided at the first three-way joint 12a flows into the water-refrigerant heat exchanger 13 and radiates heat to the high-temperature side heat medium. As a result, the high-temperature side heat medium is heated.

The refrigerant flowing out of the water-refrigerant heat exchanger 13 flows into the dehumidifying passage 21a. The flow of the refrigerant flowing into the dehumidifying passage 21a is branched at the four-way joint 12x. One of the refrigerant that branches at the four-way joint 12x flows into the air-cooling expansion valve 14b and is decompressed.

The refrigerant depressurized at the air-cooling expansion valve 14b flows into the indoor evaporator 18. The refrigerant flowing into the indoor evaporator 18 exchanges heat with the ventilation air supplied by the indoor blower 52 and evaporates. Due to this, the ventilation air is cooled and dehumidified. The refrigerant flowing out of the indoor evaporator 18 flows into one inflow port of the fifth three-way joint 12e via the second check valve 16b.

The other of the refrigerant that branches at the four-way joint 12x flows into the cooling expansion valve 14c and is decompressed. The refrigerant depressurized at the cooling expansion valve 14c flows into the chiller 20. In the hot gas dehumidifying air-heating mode, since the low-temperature side pump 41 is stopped, the chiller 20 does not exchange heat between the refrigerant and the low-temperature side heat medium. The refrigerant flowing out of the chiller 20 flows into the other inflow port of the fifth three-way joint 12e.

At the fifth three-way joint 12e, the flow of the refrigerant flowing out of the indoor evaporator 18 and the flow of the refrigerant flowing out of the chiller 20 are joined. The refrigerant flowing out of the fifth three-way joint 12e flows into the other inflow port of the sixth three-way joint 12f.

The other refrigerant branched at the first three-way joint 12a flows into the bypass passage 21c. The refrigerant flowing into the bypass passage 21c is decompressed when the flow rate is regulated by the bypass-side flow rate regulating valve 14d, as in the hot gas air-heating mode. The refrigerant depressurized at the bypass-side flow rate regulating valve 14d flows into one inflow port of the sixth three-way joint 12f.

The refrigerant flowing out of the fifth three-way joint 12e and the refrigerant flowing out of the bypass-side flow rate regulating valve 14d are joined and mixed at the sixth three-way joint 12f. The refrigerant flowing out of the sixth three-way joint 12f is mixed when flowing through the suction-side passage 21d, and is drawn into the compressor 11.

As described above, in the heat pump cycle 10 in the hot gas dehumidifying air-heating mode, the refrigerant circuit is switched to a refrigerant circuit in which refrigerants with different enthalpies, such as the low-enthalpy refrigerant flowing out of the chiller 20, the high-enthalpy refrigerant flowing out of the bypass passage 21c, and the refrigerant flowing out of the indoor evaporator 18, are mixed and sucked into the compressor 11.

Therefore, in the heat pump cycle 10 in the hot gas dehumidifying air-heating mode, the air-cooling expansion valve 14b and the cooling expansion valve 14c serve as the heating-unit side decompression unit.

In the high-temperature side heat medium circuit 30 in the hot gas dehumidifying air-heating mode, the high-temperature side heat medium heated by the water-refrigerant heat exchanger 13 flows into the heater core 32 as in the air-cooling mode. In the indoor air conditioning unit 50 in the hot gas dehumidifying air-heating mode, the ventilation air with a regulated temperature is blown into the vehicle interior, so that the air in the vehicle interior is dehumidified and heated, as in the series dehumidifying air-heating mode.

Here, the hot gas dehumidifying air-heating mode is an operation mode in which the ventilation air is cooled and dehumidified, and the dehumidified ventilation air is reheated to a desired temperature and blown into the vehicle interior. For this reason, in the hot gas dehumidifying air-heating mode, it is necessary to regulate the amount of work of the compressor 11 in a manner that the temperature of the ventilation air can be reheated to a desired temperature by the heating unit without causing frosting on the indoor evaporator 18.

In the hot gas dehumidifying air-heating mode of the present embodiment, the refrigerant with relatively high enthalpy flows into the sixth three-way joint 12f via the bypass passage 21c. Even when the refrigerant discharge performance of the compressor 11 is increased, it is possible to prevent the suction refrigerant pressure Ps from decreasing. As a result, the amount of heat radiated from the discharge refrigerant to the high-temperature side heat medium in the water-refrigerant heat exchanger 13 can be increased without causing frost formation in the indoor evaporator 18.

Therefore, in the hot gas dehumidifying air-heating mode, the ventilation air can be heated with higher heating performance than in the series dehumidifying air-heating mode.

### (g) Hot Gas Series Dehumidifying Air-Heating Mode

The hot gas series dehumidifying air-heating mode is an operation mode in which the air in the vehicle interior is dehumidified and heated. In the control program, the hot gas series dehumidifying air-heating mode is selected when it is determined that the heating performance of the ventilation air in the water-refrigerant heat exchanger 13 is insufficient in the series dehumidifying air-heating mode.

In the heat pump cycle 10 in the hot gas series dehumidifying air-heating mode, the control device 60 brings the air-heating expansion valve 14a into the throttled state, brings the air-cooling expansion valve 14b into the throttled state, brings the cooling expansion valve 14c into the throttled state, and brings the bypass-side flow rate regulating valve 14d into the throttled state. In addition, the control device 60 closes the dehumidifying on-off valve 22a and also closes the air-heating on-off valve 22b.

Therefore, in the heat pump cycle 10 in the hot gas series dehumidifying air-heating mode, the refrigerant discharged from the compressor 11 circulates similarly to the cooling series dehumidifying air-heating mode. At the same time, the refrigerant circuit is switched to a refrigerant circuit in which the refrigerant discharged from the compressor 11 circulates through the first three-way joint 12a, the bypass-side flow rate regulating valve 14d in the throttled state, which is provided in the bypass passage 21c, the sixth three-way joint 12f, the suction-side passage 21d, and the suction port of the compressor 11 in this order.

Furthermore, the control device 60 controls the refrigerant discharge performance of the compressor 11 in a manner that the suction refrigerant pressure Ps approaches the predetermined second target low pressure PSO2, as in the hot gas dehumidifying air-heating mode.

In addition, the control device 60 controls the throttle opening of the bypass-side flow rate regulating valve 14d in a manner that the discharge refrigerant pressure Pd approaches the target high pressure PDO, as in the hot gas air-heating mode.

The control device 60 controls the throttle opening of the air-heating expansion valve 14a and the throttle opening of the air-cooling expansion valve 14b to a predetermined throttle opening for the hot gas series dehumidifying air-heating mode.

The control device 60 also controls the throttle opening of the cooling expansion valve 14c in a manner that the degree of superheating SH of the suction refrigerant approaches the reference degree of superheating KSH, as in the hot gas dehumidifying air-heating mode.

In the high-temperature side heat medium circuit 30 in the hot gas dehumidifying air-heating mode, the control device 60 operates the high-temperature side pump 31 as in the air-cooling mode.

In the low-temperature side heat medium circuit 40 in the hot gas dehumidifying air-heating mode, the control device 60 stops the low-temperature side pump 41.

In the indoor air conditioning unit 50 in the hot gas dehumidifying air-heating mode, the control device 60 controls the ventilation performance of the indoor blower 52 and the opening of the air mix door 54 as in the air-cooling mode. Furthermore, the control device 60 appropriately controls the operations of the other control target devices.

Therefore, in the heat pump cycle 10 in the hot gas series dehumidifying air-heating mode, the state of the refrigerant changes as follows.

The flow of the discharge refrigerant discharged from the compressor 11 is branched at the first three-way joint 12a. One of the refrigerant divided at the first three-way joint 12a flows into the water-refrigerant heat exchanger 13 and radiates heat to the high-temperature side heat medium. As a result, the high-temperature side heat medium is heated.

The refrigerant flowing out of the water refrigerant heat exchanger 13 flows into the air-heating expansion valve 14a and is decompressed. The refrigerant decompressed at the air-heating expansion valve 14a flows into the outdoor heat exchanger 15. The refrigerant that has has flowed into the outdoor heat exchanger 15 exchanges heat with the outside air and decreases its enthalpy.

The flow of the refrigerant flowing from the outdoor heat exchanger 15 is branched at the four-way joint 12x. One of the refrigerant that branches at the four-way joint 12x flows into the air-cooling expansion valve 14b and is decompressed.

The refrigerant decompressed by the air-cooling expansion valve 14b flows into the indoor evaporator 18, exchanges heat with the ventilation air supplied by the indoor blower 52, and evaporates, as in the hot gas dehumidifying air-heating mode. Due to this, the ventilation air is cooled and dehumidified. The refrigerant flowing out of the indoor evaporator 18 flows into one inflow port of the fifth three-way joint 12e via the second check valve 16b.

The other refrigerant branched at the four-way joint 12x flows into the cooling expansion valve 14c and is decompressed, as in the hot gas air-heating mode. The refrigerant depressurized at the cooling expansion valve 14c flows into the chiller 20. The refrigerant flowing out of the chiller 20 flows into the other inflow port of the fifth three-way joint 12e.

The flow of the refrigerant flowing out of the indoor evaporator 18 and the flow of the refrigerant flowing out of the chiller 20 are joined at the fifth three-way joint 12e, as in the hot gas air-heating mode. The refrigerant flowing out of the fifth three-way joint 12e flows into the other inflow port of the sixth three-way joint 12f.

The other refrigerant branched at the first three-way joint 12a flows into the bypass passage 21c. The refrigerant flowing into the bypass passage 21c is decompressed when the flow rate is regulated by the bypass-side flow rate regulating valve 14d, as in the hot gas air-heating mode. The refrigerant depressurized at the bypass-side flow rate regulating valve 14d flows into one inflow port of the sixth three-way joint 12f.

The refrigerant flowing out of the fifth three-way joint 12e and the refrigerant flowing out of the bypass-side flow rate regulating valve 14d are joined and mixed at the sixth three-way joint 12f, as in the hot gas dehumidifying air-heating mode. The refrigerant flowing out of the sixth three-way joint 12f is mixed when flowing through the suction-side passage 21d, and is drawn into the compressor 11.

As described above, in the heat pump cycle 10 in the hot gas series dehumidifying air-heating mode, the refrigerant circuit is switched to a refrigerant circuit in which refrigerants with different enthalpies, such as the low-enthalpy refrigerant flowing out of the chiller 20, the high-enthalpy refrigerant flowing out of the bypass passage 21c, and the refrigerant flowing out of the indoor evaporator 18, are mixed and sucked into the compressor 11.

Therefore, in the heat pump cycle 10 in the hot gas series dehumidifying air-heating mode, the air-heating expansion valve 14a, the air-cooling expansion valve 14b, and the cooling expansion valve 14c serve as the heating-unit side decompression unit.

In the high-temperature side heat medium circuit 30 in the hot gas series dehumidifying air-heating mode, the high-temperature side heat medium heated by the water-refrigerant heat exchanger 13 flows into the heater core 32 as in the air-cooling mode.

In the indoor air conditioning unit 50 in the hot gas series dehumidifying air-heating mode, the ventilation air with a regulated temperature is blown into the vehicle interior, so that the air in the vehicle interior is dehumidified and heated, as in the series dehumidifying air-heating mode.

In the hot gas series dehumidifying air-heating mode, it is necessary to regulate the refrigerant discharge performance of the compressor 11 in a manner that the heating unit can reheat the ventilation air to a desired temperature without causing frosting on the indoor evaporator 18, as in the hot gas dehumidifying air-heating mode.

In the hot gas series dehumidifying air-heating mode of the present embodiment, the refrigerant with relatively high enthalpy flows into the sixth three-way joint 12f via the bypass passage 21c. Therefore, even when the refrigerant discharge performance of the compressor 11 is increased, it is possible to increase the amount of heat radiated from the discharge refrigerant to the ventilation air in the water-refrigerant heat exchanger 13 without causing frosting on the indoor evaporator 18, as in the hot gas series dehumidifying air-heating mode.

As a result, in the hot gas series dehumidifying air-heating mode, the ventilation air can be heated with higher heating performance than in the series dehumidifying air-heating mode.

As described above, according to the vehicular air conditioner 1 of the present embodiment, comfortable air conditioning in the vehicle interior can be implemented by switching the operation mode.

In this embodiment, in the heater heat absorbing air-heating mode and the heater heat absorbing hot gas heating mode, the control device 60 lowers the upper limit rotation speed of the compressor 11 as the noise level acceptable for the compressor 11 decreases, and increases the amount of heat absorbed in the chiller 20 as the noise level acceptable for the compressor 11 decreases.

As a result, the amount of heat absorbed by the chiller 20 increases as the allowable noise level of the compressor 11 decreases, so that the desired heating capacity can be ensured even when the amount of work of the compressor 11 (in other words, the rotation speed of the compressor 11) is decreased. Therefore, it is possible to suppress the noise of the compressor while ensuring the necessary heating capacity.

In particular, in the heater heat absorbing hot gas air-heating mode, refrigerants with different enthalpies, such as a refrigerant with low enthalpy flowing out from the chiller 20 and a refrigerant with high enthalpy flowing out from the bypass passage 21c, are mixed and drawn into the compressor, to enable to effectively use the heat generated by the amount of work of the compressor for heating, while simultaneously suppressing compressor noise and ensuring the necessary heating capacity.

In this embodiment, the control device 60 increases the amount of heat absorbed in the chiller 20 so that the heating capacity approaches the target heating capacity as the allowable noise level of the compressor 11 decreases. This allows the amount of heat absorbed in the chiller 20 to be appropriately controlled, to enable to suppress increase in heat loss caused by an excessive increase in the amount of heat absorbed in the chiller 20.

In this embodiment, the control device 60 increases the heat generation amount of the electric heater 70 as the allowable noise level of the compressor 11 decreases. This ensures to increase the amount of heat absorbed by the chiller 20 in accordance with decrease in the allowable noise level of the compressor 11.

In this embodiment, the control device 60 decreases the upper limit rotation speed of the compressor 11 as the vehicle speed decreases. This allows the rotation speed of the compressor 11 to be decreased in accordance with decrease in the allowable noise level of the compressor 11.

### Second Embodiment

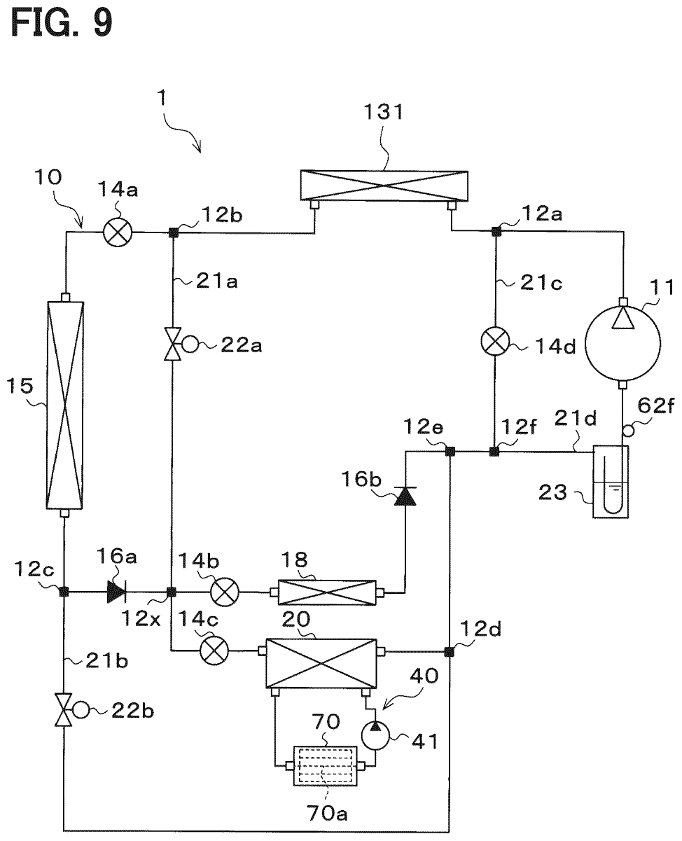

In the present embodiment shown in FIG. 9, an indoor condenser 131 is provided instead of the water-refrigerant heat exchanger 13 and the high-temperature side heat medium circuit 30 in the heat pump cycle 10 of the first embodiment. In this embodiment, an accumulator 23 is added to the heat pump cycle 10 in the vehicular air conditioner 1 of the first embodiment.

In the heat pump cycle 10, an inflow port side of a refrigerant passage in the indoor condenser 131 is connected to one outflow port of the first three-way joint 12a. The indoor condenser 131 is provided in the air conditioning case 51 of the indoor air conditioning unit 50 similarly to the heater core 32 described in the first embodiment.

The indoor condenser 131 is a heating heat exchanger that exchanges heat between the high-pressure refrigerant discharged from the compressor 11 and ventilation air passing through the indoor evaporator 18 to heat ventilation air. Therefore, the indoor condenser 131 is a heating unit heating blown air as an object to be heated by using, as a heat source, one of the discharged refrigerant branched at the first three-way joint 12a.

The accumulator 23 is provided on the outlet side of the sixth three-way joint 12f in the suction-side passage 21d. The accumulator 23 is a low-pressure side gas-liquid separating unit that separates the refrigerant flowing through the suction-side passage 21d into gas and liquid and stores the separated liquid-phase refrigerant as an excess refrigerant in the cycle. The inflow port side of the compressor 11 is connected to a gas-phase refrigerant outlet of the accumulator 23. The suction refrigerant temperature sensor 62f is provided on the downstream side in the refrigerant flow of the gas-phase refrigerant outflow port of the accumulator 23.

The remaining configurations and operation are similar to those of the first embodiment. Therefore, effects similar to those of the first embodiment can be obtained.

### Third Embodiment

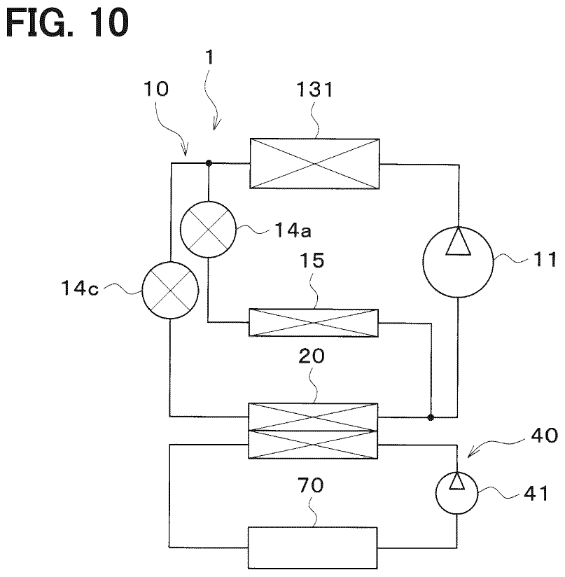

In this embodiment, as shown in FIG. 10, in the heat pump cycle 10, the air-heating expansion valve 14a and the outdoor heat exchanger 15 are arranged in parallel with the cooling expansion valve 14c and the chiller 20.

In this embodiment, the desired heating capacity is achieved by the sum of the amount of work of the compressor 11, the amount of heat absorbed by the outdoor heat exchanger 15, and the amount of heat generated by the electric heater 70.

The control device 60 controls the amount of heat absorbed by the chiller 20 (i.e., the amount of heat generated by the electric heater 70) according to the allowable noise level of the compressor 11, similarly to the heater heat absorbing air-heating mode of the first and second embodiments.

As a result, similarly to the first and second embodiments, when the allowable noise level of the compressor 11 is low, the rotation speed of the compressor 11 can be kept low to keep the noise of the compressor 11 low.

In this embodiment, the desired heating capacity is achieved by the sum of the amount of work of the compressor 11, the amount of heat absorbed by the outdoor heat exchanger 15, and the amount of heat generated by the electric heater 70. Therefore, as the amount of heat generated by the electric heater 70 increases, the rotation speed of the compressor 11 decreases, and the amount of heat absorbed by the outdoor heat exchanger 15 decreases. When the amount of heat absorbed by the outdoor heat exchanger 15 becomes too small, the system efficiency decreases.

In this regard, in the present embodiment, as the allowable noise level of the compressor 11 decreases, the amount of heat absorbed in the chiller 20 (i.e., the amount of heat generated by the electric heater 70) is increased so that the heating capacity of the heater core 32 or the water-refrigerant heat exchanger 13 (the indoor condenser 131 in the configuration of the second embodiment described above) approaches the target heating capacity, so that the compressor 11 can be operated near its upper limit rotation speed. Therefore, it is possible to suppress decrease in the system efficiency caused by an excessively small amount of heat absorption in the outdoor heat exchanger 15.

### Fourth Embodiment

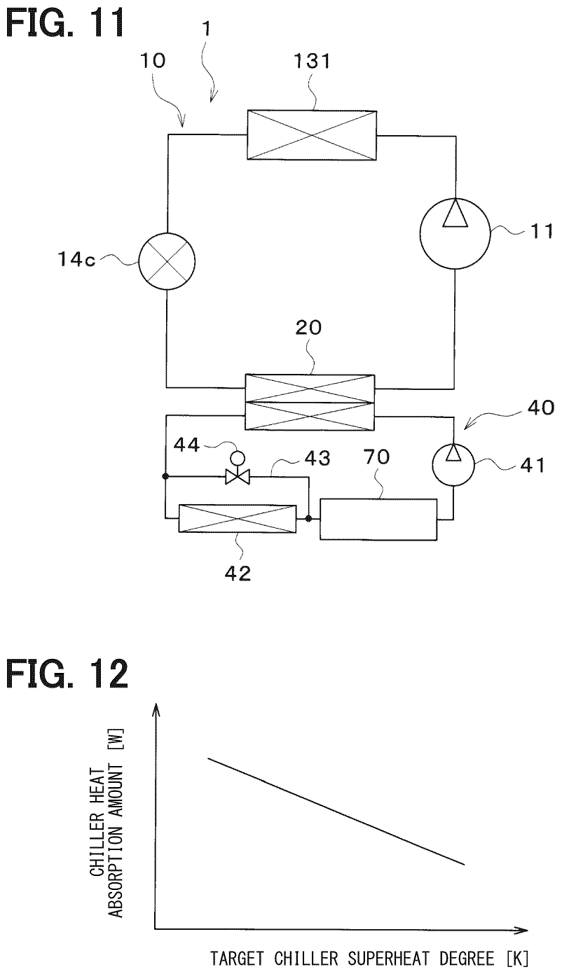

In this embodiment, as shown in FIG. 11, in the low-temperature side heat medium circuit 40, a radiator 42 is provided in series with the electric heater 70. The radiator 42 is an outside air heat exchanger that exchanges heat between the low-temperature heat medium cooled by the chiller 20 and outside air blown by an outside air fan (not shown).

A radiator bypass passage 43 and a bypass on-off valve 44 are arranged in the low-temperature side heat medium circuit 40. The radiator bypass passage 43 is a flow path through which the low-temperature side heat medium flows, while bypassing the radiator 42. The bypass on-off valve 44 is an on-off valve that opens and closes the radiator bypass passage 43. The bypass on-off valve 44 is an electromagnetic valve whose opening and closing operation is controlled by a control voltage output from the control device 60.

When the temperature of the low-temperature heat medium is higher than the temperature of the outside air, the radiator 42 cannot absorb heat from the low-temperature heat medium, so the bypass on-off valve 44 is opened to stop the flow of the low-temperature heat medium to the radiator 42.

In this embodiment, the desired heating capacity is achieved by the sum of the amount of work of the compressor 11, the amount of heat absorbed by the radiator 42, and the amount of heat generated by the electric heater 70.

The control device 60 controls the amount of heat absorbed by the chiller 20 (i.e., the amount of heat generated by the electric heater 70) according to the allowable noise level of the compressor 11, similarly to the heater heat absorbing air-heating mode of the first and second embodiments.

As a result, similarly to the first and second embodiments, when the allowable noise level of the compressor 11 is low, the rotation speed of the compressor 11 can be kept low to keep the noise of the compressor 11 low.

In this embodiment, the desired heating capacity is achieved by the sum of the amount of work of the compressor 11, the amount of heat absorbed by the radiator 42, and the amount of heat generated by the electric heater 70. Therefore, as the amount of heat generated by the electric heater 70 increases, the rotation speed of the compressor 11 decreases, and the amount of heat absorbed by the radiator 42 decreases. When the amount of heat absorbed by the radiator 42 becomes too small, the system efficiency decreases.

In this regard, in the present embodiment, as the allowable noise level of the compressor 11 decreases, the amount of heat absorbed in the chiller 20 (i.e., the amount of heat generated by the electric heater 70) is increased so that the heating capacity of the heater core 32 or the water-refrigerant heat exchanger 13 (the indoor condenser 131 in the configuration of the second embodiment described above) approaches the target heating capacity, so that the compressor 11 can be operated near its upper limit rotation speed. Therefore, it is possible to suppress decrease in the system efficiency caused by an excessively small amount of heat absorption in the radiator 42.

### Fifth Embodiment

In the above first to fourth embodiments, the amount of heat absorbed in the chiller 20 is controlled by controlling the heat generation amount of the electric heater 70. In this embodiment, the amount of heat absorbed in the chiller 20 is controlled by controlling the degree of superheat SH of the refrigerant that has been heat exchanged in the chiller 20.

Specifically, the control device 60 decreases a superheat target degree SHO of the degree of superheat SH of the refrigerant that has performed heat exchange in the chiller 20 as the allowable noise level of the compressor 11 decreases. The control device 60 controls the throttle opening degree of the cooling expansion valve 14c so that the degree of superheat SH of the refrigerant that has performed heat exchange in the chiller 20 approaches the superheat target degree SHO. That is, when the degree of superheat SH of the refrigerant that has performed heat exchange in the chiller 20 is greater than the target degree of superheat SHO, the throttle opening of the cooling expansion valve 14c is increased.

As a result, the flow rate of the refrigerant passing through the cooling expansion valve 14c increases, so that the flow rate of the refrigerant flowing through the chiller 20 also increases, and the amount of heat absorbed in the chiller 20 increases. That is, as shown in FIG. 12, the amount of heat absorbed by the chiller 20 increases as the superheat target degree SHO of the degree of superheat SH of the refrigerant that has performed heat exchange in the chiller 20 decreases. As a result, similarly to the first embodiment, when the allowable noise level of the compressor 11 is low, the rotation speed of the compressor 11 can be kept low to keep the noise of the compressor 11 low.

In this embodiment, the control device 60 decreases the degree of superheat SH of the refrigerant that has performed heat exchange in the chiller 20 in accordance with decrease in the allowable noise level of the compressor 11. This enables to quickly increase the amount of heat absorbed by the chiller 20 in accordance with decrease in the allowable noise level of the compressor 11.

The present disclosure is not limited to the embodiments described above, and can be variously modified as follows without departing from the gist of the present disclosure.

In the first embodiment described above, the allowable noise level of the compressor 11 is determined to be two levels, high and low, based on the vehicle speed. The allowable noise level of the compressor 11 may also be determined continuously based on the vehicle speed.

That is, the allowable noise level of the compressor 11 may be continuously decreased as the vehicle speed decreases.

Furthermore, in the above-described embodiment, the upper limit rotation speed of the compressor 11 is determined in two stages, the first upper limit rotation speed NcImt1 and the second upper limit rotation speed NcImt2, based on the allowable noise level of the compressor 11. However, the upper limit rotation speed of the compressor 11 may be determined continuously based on the allowable noise level of the compressor 11.

That is, the upper limit rotation speed of the compressor 11 may be continuously decreased as the allowable noise level of the compressor 11 decreases.

The configuration of the heat pump cycle device according to the present disclosure is not limited to the configurations disclosed in the above embodiments.

In the first and second embodiments described above, the other inflow port of the sixth three-way joint 12f is connected to the outlet side of the fifth three-way joint 12e, and the outflow port of the sixth three-way joint 12f is connected to the suction side of the compressor 11. However, the other inflow port of the sixth three-way joint 12f may be connected to the outlet side of the cooling expansion valve 14c, and the outflow port of the sixth three-way joint 12f may be connected to the inlet side of the chiller 20.

In the second embodiment described above, the refrigerant that has flowed through the bypass passage 21c flows into the accumulator 23 via the sixth three-way joint 12f. However, the refrigerant that has flowed through the bypass passage 21c may also flow directly into the accumulator 23 without passing through the sixth three-way joint 12f.

In the above-described embodiments, the heating element arranged in the low-temperature side heat medium circuit 40 is the electric heater 70, but this is not limited to this, and the heating element arranged in the low-temperature side heat medium circuit 40 may be various heating elements whose heat generation amount can be controlled by a control signal output from the control device 60.

In the above embodiments, the example in which the second check valve 16b is used has been described, but an evaporation pressure regulating valve may be used instead of the second check valve 16b. The evaporation pressure regulating valve is a variable throttle mechanism that maintains a refrigerant evaporating temperature in the indoor evaporator 18 at a predetermined temperature (for example, temperature at which the indoor evaporator 18 can be suppressed) or higher.

As the evaporation pressure regulating valve, a variable throttle mechanism including a mechanical mechanism that increases a valve opening as the pressure of the refrigerant on the refrigerant outflow port side of the indoor evaporator 18 increases may be used. As the evaporation pressure regulating valve, a variable throttle mechanism including an electric mechanism similar to that of the air-heating expansion valve 14a or the like may be used.

The control sensor group connected to the input side of the control device 60 is not limited to the detection units disclosed in the above embodiments. Various detection units may be added as necessary.

In the above embodiment, the example in which R1234yf is employed as the refrigerant of the heat pump cycle 10 has been described, but the present embodiment is not limited thereto. For example, R134a, R600a, R410A, R404A, R32, R407C, and the like may be employed. Alternatively, a mixed refrigerant or the like in which multiple types of those refrigerants are mixed together may be employed. Furthermore, carbon dioxide may be used as the refrigerant to form a supercritical refrigeration cycle in which the high-pressure side refrigerant pressure is equal to or higher than the critical pressure of the refrigerant.

The example of using an ethylene glycol aqueous solution as the low-temperature side heat medium and the high-temperature side heat medium of the embodiments described above has been described, but it is not limited thereto. As the high-temperature side heat medium and the low-temperature side heat medium, for example, dimethylpolysiloxane, a solution containing nanofluid or the like, an antifreeze liquid, an aqueous liquid refrigerant containing alcohol or the like, a liquid medium containing oil or the like, and the like may be used.

The control mode of the heat pump cycle device according to the present disclosure is not limited to the control modes disclosed in the above embodiments.

In the above-described embodiment, the vehicular air conditioner 1 capable of executing various operation modes has been described. However, the heat pump cycle apparatus according to the present disclosure is not necessarily capable of executing all the above-described operation modes.

The heat pump cycle device according to the present disclosure can obtain effects similar to those of the above embodiments as long as the heat pump cycle device can perform at least one of the heater heat absorbing air-heating mode and the heater heat absorbing hot gas air-heating mode. That is, even in the heat pump cycle device in which refrigerants with different enthalpies are mixed and sucked into the compressor, the compressor 11 can be protected without deteriorating productivity. Furthermore, other operation modes may be able to be performed.

In addition, the control mode of the control device 60 in the heater heat absorbing air-heating mode is not limited to the examples disclosed in the above embodiments.

For example, in the above-described embodiment, the control device 60 determines the allowable noise level of the compressor 11 based on the vehicle speed. However, the control device 60 may also determine the allowable noise level of the compressor 11 based on the air volume (in other words, the rotation speed) of the indoor blower 52 or the air volume (in other words, the rotation speed) of an outdoor air fan not shown. This is because when the air volume of the indoor blower 52 or the outdoor air fan is large, the noise of the compressor 11 is easily drowned out by the operating sound and blowing sound of the indoor blower 52 and the outdoor air fan. This also applies to the heater heat absorbing hot gas air-heating mode.

In the present embodiment, the control device 60 decreases the upper limit rotation speed of the compressor 11 as the air flow rate of the indoor blower 52 decreases. This allows the rotation speed of the compressor 11 to be decreased in accordance with decrease in the allowable noise level of the compressor 11.

In this embodiment, the control device 60 decreases the upper limit rotation speed of the compressor 11 in accordance with decrease in the blowing amount of the outside air fan that blows outside air. This allows the rotation speed of the compressor to be decreased in accordance with decrease in the allowable noise level of the compressor.

The present disclosure has been described in accordance with examples, but it is understood that the present disclosure is not limited to the examples and structures. The present disclosure encompasses various modifications and variations within the scope of equivalents. In addition, various combinations and modes, and other combinations and modes including only one element, more elements, or less elements are also within the scope and idea of the present disclosure.

The vehicle heat pump cycle device disclosed in this specification has the following features.

### (Item 1)

A vehicular heat pump cycle device includes: a compressor (11) configured to draw, compress, and discharge refrigerant; a heating unit (13, 131) configured to heat an object to be heated using, as a heat source, refrigerant discharged from the compressor; a decompression unit (14c) configured to decompress refrigerant flowing out of the heating unit; and a heat absorbing unit (20) configured to cause refrigerant, which is decompressed by the decompression unit, to absorb heat generated by a heat generating unit (70), in which the heat absorbing unit is configured to increase an amount of absorbed heat according to decrease in an allowable noise level of the compressor.

### (Item 2)

A vehicular heat pump cycle device includes: a compressor (11) configured to draw, compress, and discharge refrigerant; a heating unit (13, 131) configured to heat an object to be heated using, as a heat source, refrigerant discharged from the compressor; a decompression unit (14c) configured to decompress refrigerant flowing out of the heating unit; a heat absorbing unit (20) configured to cause refrigerant, which is decompressed by the decompression unit, to absorb heat generated by a heat generating unit (70); and an upper limit rotation speed determination unit (60a) configured to determine an upper limit rotation speed of the compressor, in which the upper limit rotation speed determination unit is configured to lower the upper limit rotation speed according to decrease in an allowable noise level of the compressor, and the heat absorbing unit is configured to increase an amount of absorbed heat according to decrease in the allowable noise level of the compressor.

### (Item 3)

The vehicular heat pump cycle device according to item 2, further includes: a target heating capacity determination unit (60d) configured to determine a target heating capacity of the heating unit, in which the heat absorbing unit is configured to increase the amount of absorbed heat, so that the heating capacity of the heating unit approaches the target heating capacity according to decrease in the allowable noise level of the compressor.

### (Item 4)

The vehicular heat pump cycle device according to item 2 or 3, in which the heat generating unit is configured to increase an amount of generated heat according to decrease in the allowable noise level of the compressor.

### (Item 5)

The vehicular heat pump cycle device according to item 2 or 3, in which the decompression unit is configured to decrease a superheat degree of refrigerant, which has performed heat exchange in the heat absorbing unit, according to decrease in the allowable noise level of the compressor.

### (Item 6)

The vehicular heat pump cycle device according to any one of items 2 to 5, in which the upper limit rotation speed determination unit is configured to decrease the upper limit rotation speed, as a vehicle speed decreases.

### (Item 7)

The vehicular heat pump cycle device according to any one of items 2 to 5, in which the upper limit rotation speed determination unit is configured to decrease the upper limit rotation speed according to decrease in an air flow rate of a blower unit (52) that is configured to blow air toward a vehicle interior.

### (Item 8)

The vehicular heat pump cycle device according to any one of items 2 to 5, in which the upper limit rotation speed determination unit is configured to decrease the upper limit rotation speed according to decrease in an air flow rate of an outside air fan that is configured to blow outside air.

### (Item 9)

The vehicular heat pump cycle device according to any one of items 1 to 8, further includes: a branch portion (12a) configured to branch flow of refrigerant discharged from the compressor into a side of the heating unit and an other side; a bypass passage (21c) configured to circulate refrigerant branched to the other at the branch portion; a flow rate regulating unit (14d) configured to regulate a flow rate of refrigerant flowing through the bypass passage; and a joining unit (12f) configured to join refrigerant, which flows out of the decompression unit, and refrigerant, which flows out of the flow rate regulating unit, and cause the refrigerant to flow to an inflow port of the compressor.

What is claimed is:

1. A vehicular heat pump cycle device comprising:
a compressor configured to draw, compress, and discharge refrigerant;
a heating unit configured to heat an object to be heated using, as a heat source, refrigerant discharged from the compressor;
a decompression unit configured to decompress refrigerant flowing out of the heating unit; and
a heat absorbing unit configured to cause refrigerant, which is decompressed by the decompression unit, to absorb heat generated by a heat generating unit, wherein
the heat absorbing unit is configured to increase an amount of absorbed heat according to decrease in an allowable noise level of the compressor.

2. A vehicular heat pump cycle device comprising:
a compressor configured to draw, compress, and discharge refrigerant;
a heating unit configured to heat an object to be heated using, as a heat source, refrigerant discharged from the compressor;
a decompression unit configured to decompress refrigerant flowing out of the heating unit;
a heat absorbing unit configured to cause refrigerant, which is decompressed by the decompression unit, to absorb heat generated by a heat generating unit; and
an upper limit rotation speed determination unit configured to determine an upper limit rotation speed of the compressor, wherein
the upper limit rotation speed determination unit is configured to lower the upper limit rotation speed according to decrease in an allowable noise level of the compressor, and
the heat absorbing unit is configured to increase an amount of absorbed heat according to decrease in the allowable noise level of the compressor.

3. The vehicular heat pump cycle device according to claim 2, further comprising:
a target heating capacity determination unit configured to determine a target heating capacity of the heating unit, wherein
the heat absorbing unit is configured to increase the amount of absorbed heat, so that the heating capacity of the heating unit approaches the target heating capacity according to decrease in the allowable noise level of the compressor.

4. The vehicular heat pump cycle device according to claim 2, wherein
the heat generating unit is configured to increase an amount of generated heat according to decrease in the allowable noise level of the compressor.

5. The vehicular heat pump cycle device according to claim 2, wherein
the decompression unit is configured to decrease a superheat degree of refrigerant, which has performed heat exchange in the heat absorbing unit, according to decrease in the allowable noise level of the compressor.

6. The vehicular heat pump cycle device according to claim 2, wherein
the upper limit rotation speed determination unit is configured to decrease the upper limit rotation speed, as a vehicle speed decreases.

7. The vehicular heat pump cycle device according to claim 2, wherein
the upper limit rotation speed determination unit is configured to decrease the upper limit rotation speed according to decrease in an air flow rate of a blower unit that is configured to blow air toward a vehicle interior.

8. The vehicular heat pump cycle device according to claim 2, wherein
the upper limit rotation speed determination unit is configured to decrease the upper limit rotation speed according to decrease in an air flow rate of an outside air fan that is configured to blow outside air.

9. The vehicular heat pump cycle device according to claim 2, further comprising:
a branch portion configured to branch flow of refrigerant discharged from the compressor into a side of the heating unit and an other side;
a bypass passage configured to circulate refrigerant branched to the other at the branch portion;
a flow rate regulating unit configured to regulate a flow rate of refrigerant flowing through the bypass passage; and
a joining unit configured to join refrigerant, which flows out of the decompression unit, and refrigerant, which flows out of the flow rate regulating unit, and cause the refrigerant to flow to an inflow port of the compressor.

10. A vehicular heat pump cycle device comprising:
a compressor configured to draw, compress, and discharge refrigerant;
a heating device configured to heat an object to be heated using, as a heat source, refrigerant discharged from the compressor;
a decompressing device configured to decompress refrigerant flowing out of the heating device;
a heat absorbing device configured to cause refrigerant, which is decompressed by the decompressing device, to absorb heat generated by a heat generating device; and
at least one of (i) a circuit and (ii) a processor having a memory storing computer program code, wherein the at least one of the circuit and the processor having the memory is configured to cause the heat absorbing device to increase an amount of absorbed heat according to decrease in an allowable noise level of the compressor.

11. The vehicular heat pump cycle device according to claim 10, wherein
the at least one of the circuit and the processor having the memory is further configured to
determine an upper limit rotation speed of the compressor, and
lower the upper limit rotation speed according to decrease in the allowable noise level of the compressor.
